(19) United States
(12) Patent Application Publication
(10) Pub. No.: US 2005/0052080 A1
(43) Pub. Date: Mar. 10, 2005

(54) Adaptive electric car

(76) Inventors: Boris A. Maslov, Reston, VA (US); Kevin Pavlov, Dulles, VA (US)

Correspondence Address: MORRISON & FOERSTER LLP, 1650 TYSONS BOULEVARD, SUITE 300, MCLEAN, VA, 22102, US

(21) Appl. No.: 10/736,901

(22) Filed: Dec. 17, 2003

Related U.S. Application Data
(63) Continuation-in-part of application No. 10/359,305, filed on Feb. 6, 2003.
(60) Provisional application No. 60/399,415, filed on Jul. 31, 2002.

(51) Int. Cl. B60L 3/00

(52) U.S. Cl. 307/10.1

(57) ABSTRACT

An adaptive electric car or other vehicle with potentially better performance—power, efficiency, range—than a gasoline vehicle, at a competitive cost. The motor control system can dynamically adapt to the vehicle's operating conditions (starting, accelerating, turning, braking, cruising at high speeds) and other inputs and parameters. That consistently provides better performance. Isolating the vehicle's motor or generator electromagnetic circuits allows effective control of more independent parameters. That gives great freedom to optimize. Adaptive motors and generators for an electric vehicle are cheaper, smaller, lighter, more powerful, and more efficient than conventional designs. An electric vehicle with in-wheel adaptive motors delivers high power with low unsprung mass and high torque and power-density. Total energy management of the vehicles entire electrical system allows for large-scale optimization. An adaptive architecture improves performance of a wide variety of vehicles, particularly those that need optimal efficiency over a range of operating conditions.

### STATEMENT OF RELATED APPLICATION

This application is a continuation-in-part of U.S. application Ser. No. 10/359,305 filed Feb. 6, 2003, which application claims priority from commonly assigned, copending U.S. application Ser. No. 09/826,423 of Maslov et al., filed Apr. 5, 2001, commonly assigned, copending U.S. application Ser. No. 09/826,422 of Maslov et al., filed Apr. 5, 2001, commonly assigned, copending U.S. application Ser. No. 09/966,102, of Maslov et al., filed Oct. 1, 2001, commonly assigned, copending U.S. application Ser. No. 09/993,596 of Pyntikov et al., filed Nov. 27, 2001, commonly assigned, copending U.S. application Ser. No. 10/173,610, of Maslov et al., filed Jun. 19, 2002, commonly assigned, U.S. Application Ser. No. 60/399,415, of Maslov et al., filed Jul. 31, 2002, commonly assigned, copending U.S. application Ser. No. 10/290,537, of Maslov et al., filed Nov. 8, 2002, commonly assigned, copending U.S. application Ser. No. 10/353,075 of Maslov et al., filed Jan. 29, 2003, and commonly assigned, copending U.S. application Ser. No. 10/353,075 of Maslov et al., filed Jan. 29, 2003, each of which is hereby incorporated by reference in its entirety.

### FIELD OF INVENTION

This invention relates to electric cars and other electric vehicles.

### BACKGROUND OF THE INVENTION

Gasoline cars took over the global car market in the 1910s, and currently dominate the market. Gasoline-powered cars, despite their long history and widespread acceptance, have weaknesses. They produce pollution, they are noisy, and their fuel sources are limited due to their dependence on fossil fuels. Gasoline-powered vehicles also have many moving parts that require lubrication and frequent maintenance. These parts wear out and these cars break down often. Most of all, gasoline cars are inefficient, due to the inherent limitations of thermodynamic engines.

In theory, electric cars have strong advantages over gasoline cars. Pure electric cars have no emissions, and hybrids have few. Electric cars are quiet. The electricity they use can come from a variety of sources. They have few moving parts and require little maintenance. For the same reason, they do not break down often and are more reliable. Most of all, they are efficient, many times as efficient as gasoline cars.

But electric cars, despite their advantages, also have weaknesses. Compared to gasoline cars, they tend to perform poorly, weigh more (principally because of batteries), have less space (also because of batteries), have limited range, and cost more. Hybrid electric cars may overcome some of these weaknesses, such as limited range and poor performance, to some degree. But hybrid cars worsen the problems of complexity, size, weight and cost.

Gasoline cars continue to dominate the passenger car and light truck market, which some estimates put at an annual figure of $650 billion in the United States. In 1999, global sales of automobiles and light trucks topped 56 million vehicles. If adaptive electric cars can compete in that market, and gain even a tiny share, the financial rewards will be great.

Virtually every vehicle on the road today is powered by a gasoline or diesel engine. Historically, gasoline cars have provided more power, more convenience, and longer range at a cheaper price than electric cars. That is still true today.

The reasons for the dominance of gasoline cars are complex. But the main reason probably lies in the nature of electricity compared to gasoline. Stored electricity does not move easily. Stored gasoline does.

Just like gasoline monopolizes applications producing mobile power, electricity monopolizes stationary power. The workhouse of modern society is the electric motor. But as soon as a motor needs to be mobile, it invariably becomes a gasoline engine. (Except for subways, some trains, some buses and streetcars, where a constant supply of electricity is available over the required distance.)

Why do we use gasoline engines for almost all vehicles? Because gasoline is easily portable. Gasoline has very high energy density, about 45,300 Btu in each kilogram. The typical lead acid battery stores electricity at very low energy density, about 125 Btu in each kilogram.

That gasoline can, in theory at least, deliver 360 times the energy of an electric battery literally gives gasoline cars energy to bum. And the tank of a gasoline car can usually be filled in four to five minutes. The charging of a battery usually requires at least four to five hours. Gasoline's advantage as an energy source makes a big difference.

In 1895, the Chicago Times-Herald sponsored America's first formal car race, a 50-mile endurance test. Just two of the six entrants finished. The winner was powered by an engine using a little-known, dangerous and unstable byproduct of kerosene refining: gasoline.

In the more than 100 years since, the gasoline engine has proven to be the most powerful, reliable, relatively cheap and adaptable source of propulsion yet invented. The gasoline engine has been continually modified to meet ever greater challenges of reducing emissions and increasing fuel economy.

To meet federal and state mandates, carmakers have modified gasoline engines to burn cleaner, unleaded gasoline; installed catalytic converters and sophisticated exhaust control systems; developed better transmissions, fuel injection systems and multivalve engines to improve fuel delivery and burning; created more aerodynamic styling to reduce drag; and used lightweight materials, such as aluminum and plastics.

The use of aluminum in production gasoline cars provides a good example. In the quest for fuel efficiency, more aluminum is being used in car manufacturing to make lighter cars. In 1980 aluminum made up approximately 3 percent (about 75 pounds) of a typical midsize car. In 1990 it was about 5 percent. Forecasts for cars of the future indicate that aluminum usage will rise to between 10 percent and 20 percent of the total vehicle weight, with engine blocks, cylinder heads, and housings being made partly or completely of aluminum alloys.

As more and more light-metal components are used in making cars, steps have been taken to use advanced materials so that these lighter weight components hold up under punishing conditions. Often the lightweight components can be reinforced with high-performance ceramics at high-stress locations.

For composites from metal and ceramics (Metal Matrix Composites, MMC or Ceramic Matrix Composites, CMC), a metallic substrate with ceramic hardened particles is used as reinforcement. The low weight of the metal can thus be combined with the resistance of ceramics to conditions of high tribological (friction and wear), mechanical, chemical and thermal stress.

Compared to this long history of innovation and improvement, electric cars have not been competitive for almost a century. By 1920, the electric car was essentially dead in the market. Today, a Ford executive's comments reflect the view of most carmakers: “While we likely will see some alternatives, Ford believes the internal combustion engine will continue to be the major element in the foreseeable future.”

The high energy density of gasoline gives gasoline cars energy to burn. Big engines and powerful transmissions have become affordable and commonplace. Lighter materials, advanced designs, and advanced cooling, fuel injection and lubrication systems have made large horsepower engines practical and reliable. While big engines do use a lot of gasoline, fuel economy has been improved even for high power engines.

When a car is traveling down a level highway at cruising speed, the engine is doing three things:
Overcoming rolling resistance in the drive train.
Overcoming air resistance.
Powering accessories like the alternator, the air conditioner, and the power steering pump.
   With proper gearing, the car's engine probably needs to produce no more than 10 or 20 horsepower to carry this load.

The reason why cars have 100 or 200 horsepower engines is to accelerate today's big, heavy cars from a standing stop, as well as for passing and hill climbing. Maximum horsepower may be used in many cases for only 1% of the driving time. But drivers will notice when power is not available when wanted.

A typical four-door sedan may have an engine rated at, say, 200 horsepower. It requires the full 200 horsepower very little of the time, normally only for quick passing maneuvers or while climbing steep hills. The vast majority of the time the engine is operating at a small fraction of its full output.

Once the sedan is at freeway speed, as little as 20 or 30 horsepower may be needed to keep it moving. In fact, many drivers may seldom, if ever, call upon the full power output of the engines under their cars' hoods. What people really need is 200 horsepower every once in a while, maybe 100 horsepower from time to time, and about 30 or 40 horsepower most of the time.

Power demand in a car also increases during cold or hot weather, as heating and defrosting or air conditioning will increase power demands. Air conditioners, for example, typically siphon off 25% or more of the engine's power when the compressor is running. Amenities such as sound systems, DVD players, power windows, heated seats, and other equipment also require power to operate.

All of the amenities that consumers want, as well as climbing hills, accelerating from a standing stop, accelerating to pass, carrying a heavy load of cargo, and towing boats and trailers, make big power demands. We expect today's gasoline engines to meet those power demands. And they do.

Many believe long range to be the biggest advantage of gasoline cars over electric cars. A typical driver will be satisfied with a range of about 250 miles before needing to refuel. Modem gasoline cars can satisfy that with ease. Most cars will travel 300 to 500 miles on a tank of gas. Some now have ranges well over that. The 2004 Toyota Prius, for example, promises an average range of 660 miles on one tank of gas.

With the gasoline refueling infrastructure well in place in most places of the world, and refueling taking only a few minutes, range is not a problem for gasoline cars. As electric car advocates point out, most commuters take round trips of 50 miles or less. A range well under 100 miles before recharging would be sufficient for almost all drivers.

But the distance limitation is psychologically important. Even in the earliest days when gasoline stands were rare, most car owners wanted a car that was capable of “touring,” even though they rarely used them for that purpose. Even today, most sport-utility-vehicle buyers never go off road, but they pay a lot more for a car that provides them that fantasy.

In addition, the amenities that most car owners prefer—air-conditioning, power windows, and other electrical accessories—drain power. Even using headlights at night will usually have some effect on range. With a gasoline car, the effect of these range-limiting factors may barely be noticed.

With electric cars of the prior art, the effect will often be severe, sometimes restricting the car's already limited range by 25% or even more. With recharging facilities scarce and recharging time lengthy, a driver trying to stretch the range of an electric car to reach home may have no good options if the car's batteries run out a few miles short.

The cost of a car heavily influences consumers. And the cost of the car's propulsion system heavily influences cost. Many parts of a gasoline car and an electric car will be identical, particularly for parallel hybrid cars. Here again, though, the difference in energy density between gasoline and electricity plays a role. This difference affects an electric car's weight, interior space, power, and most importantly cost. As a mobile energy source, gasoline cannot be beat in either range or cost.

Gasoline cars are cheaper to make than electric cars. The problem is the power source. One auto executive pointed out that: “It's not hard to see that we can build an electric car that's as cheap, or maybe even slightly cheaper than our current gasoline cars, but it's very hard to see how I'm going to take a battery and have it compete in cost with a $50 fuel tank. The bottom line on cost is the battery.”

In addition to expensive batteries, prior art electric cars also require other expensive equipment and options to keep weight low, reduce air resistance, and increase range. And today only 12 major carmakers have most of the global car market. They sell large volumes of the same cars, so that economies of scale help reduce costs. That makes gasoline cars significantly less expensive than electric cars. Fuel costs may also be lower for gasoline cars. The economics of fuel costs can be seen by looking at a normal production gasoline car converted to electric drive. The gasoline engine, the gas tank, and related components were replaced by an electric motor and lead-acid batteries. Here are some interesting statistics:
The range of the converted car is about 50 miles per charge.
Recharging time is 6 to 8 hours.
About 12 kilowatt-hours of electricity are needed to fully recharge the batteries.
The batteries weigh about 1,100 pounds.
The batteries last three to four years, or about 20,000 miles.

If electricity costs 8 cents per kilowatt-hour, a full recharge costs $1, and the electricity cost is 2 cents per mile. If gasoline costs $1.50 per gallon and a car gets 30 miles to the gallon, then the gasoline cost is five cents per mile.

But the cost of battery replacement must also be considered (a gasoline tank need not be replaced). Battery replacement would be about $2,000. The batteries will last about 20,000 miles, so battery costs will be about 10 cents per mile. So comparable fuel costs would be 5 cents for gasoline compared to 12 cents for electric.

Of course, in some European countries, gasoline prices are much higher than in the United States. In those countries, the gasoline cost may be comparable to, or even exceed, the cost of electricity. And in Japan, for example, both gasoline and electricity costs more than in the United States. That makes comparisons difficult.

Cheap gasoline cannot last forever. But gasoline prices in the United States, and most other countries, have remained relatively stable for decades. Certainly the cost of gasoline at the pump does not reflect all economic costs in getting the gasoline there. Subsidies, tax breaks, even the costs of military action in the Persian Gulf, might fairly be considered part of the cost of gasoline.

Even so, in 2003 the retail price of a gallon of gasoline (less taxes) was estimated to be an average of 90 cents in the United States. That price covers oil exploration, drilling, extraction, transportation of crude oil, refining, transportation of gasoline, and the retailer's margin. Bottled water usually costs more to buy. Given the energy contained in that gallon of gasoline, that price is difficult to beat.

Back in 1905 when gasoline cars started to become commercially available in the United States, gasoline was not readily available. Kerosene was. It was available in drugstores and at grocers. Gasoline was a relatively worthless byproduct of petroleum refining, sometimes just dumped or burned off. That quickly changed.

Today, gasoline can be purchased readily almost anywhere in the world. Wars have been fought to secure a stable supply of petroleum. Exploration for oil, extraction technology, supertankers to transport large amounts of crude oil, refining of gasoline from oil, and infrastructure for distributing and selling gasoline have all been the focus of immense investment.

Today, battery and recharging technology and infrastructure lag well behind those for gasoline. Recharging spots for electric cars have been put in the parking lots of airports, government offices, and some big corporate facilities. Often they go unused. Perhaps the electrical outlets in home garages can be used for recharging at home. But however looked at, the infrastructure for gasoline cars dwarfs the electric car recharging infrastructure in the United States.

Under government pressure, carmakers have greatly reduced tailpipe emissions from gasoline cars. Gasoline cars are by some measures over 90% cleaner than they were in the 1960s. In 2001, gasoline engines powered 10 of the 13 “greenest” cars and trucks evaluated by an environmental group. Electric and alternate-fuel vehicles had dominated past winners lists.

Carmakers also improved fuel efficiency. In the mid-1960s, cars averaged 14 miles per gallon (mpg), while 1998 models were required by the federal government to average 27.5 mpg. According to one environmental group, the doubling of fuel economy since the 1960s has saved hundreds of millions of tons of air pollutants.

But the numbers of cars on the road and vehicle miles traveled have also increased dramatically since the 1960s. Gasoline-burning cars are still a major contributor to air quality problems. The gasoline engine and other major automotive components must continue to be changed to reduce emissions even further. Carmakers are making efforts to do so.

For example, Honda produced a “Z-LEV” version of the 2.3-liter, four-cylinder engine found in the Accord. Honda claimed that the engine was nearly pollution-free, with emissions of carbon monoxide and nitrogen oxide down to 10 percent of California's very tough standards. “In some high smog areas like Los Angeles, the Z-LEV's tailpipe emissions can be cleaner than the surrounding air,” a Honda representative said.

Consumers, in the United States at least, have shown a strong appetite for cars with the power, range, amenities and space of modern gasoline engine cars. Sports-utility vehicles, despite their high sales prices and low fuel economy, sell very well in the United States. They are popular because they are big, powerful, comfortable cars.

Smaller, cheaper cars with higher fuel economy—whether gasoline or electric—do sell. But carmakers need to meet increased consumer expectations. Basic transportation is not what the market is buying. The status, luxury and comfort provided by cars are key sales points for consumers in the developed countries.

An important issue with all vehicles are the extra amenities that consumers need for comfort. Air conditioning and a basic sound system have become essentials rather than options. Some new vehicles on the market in the United States now offer “surround sound,” DVD movie players in “entertainment centers,” GSP-based navigation systems, and seats that support or treat the sore back. These amenities take up space and use up power, something much less available in electric cars than gasoline cars.

Most importantly, gasoline cars have set the standard for what consumers expect from cars in terms of things like style, convenience, roominess, power, range, fuel cost, and vehicle cost. Gasoline cars have earned their market over more than a century of competition. Expensive, small, cramped, slow and stodgy electric cars with limited range and few amenities have proven one thing: “green” consciousness and conserving natural resources are sales points that appeal to only a small fraction of the consuming public.

While we use the term “gasoline cars,” the more broad term “internal combustion engine vehicles” may be more appropriate. With some design differences, these vehicles can run on different kinds of fuel: gasoline of various octanes, diesel fuel, alcohol, natural gas, and other high energy fuels. But the fuel must be an explosive liquid or gas. The number of those are limited.

Some improvements have been made over the years. Certainly new-generation diesel engines have shown that these reliable, high-efficiency engines can replace gasoline engines in some cases.

The vast majority of modern heavy road vehicles, ships, most long-distance locomotives, large-scale portable power generators, and most farm and mining vehicles have diesel engines. This is because diesel engines are more fuel-efficient than comparably powerful gasoline engines and have proven to be extremely reliable and dependable.

However, diesel engines have not been nearly as popular in passenger vehicles. Diesel engines have been heavier and noisier. They have had performance characteristics which make them slower to accelerate, and more expensive than gasoline vehicles. But in Europe, where tax rates in many countries make diesel fuel much cheaper than gasoline, diesel vehicles are very popular.

Newer designs have significantly narrowed differences between gasoline and diesel vehicles in the areas mentioned. In one perhaps amusing example of this, Formula One driver Jenson Button was arrested driving a diesel-powered BMW coupe at 230 km/h (about 140 mph). Some thought such speeds would be impossible in a production diesel car.

Today, though, the cost, lifetime and reliability of gasoline cars are all being squeezed. The gasoline engine is not at a technical standstill. But improvements inch along at high costs for small gains. Expensive, complicated new technologies must be developed every year in order to provide new functions and conveniences to drivers and passengers, to reduce pollution, and to increase mileage.

From the mass of social and technical constraints surrounding the gasoline car mentioned below—mechanical inefficiency, scarcity of petroleum, vulnerability of petroleum supplies coming from foreign countries, cost of gasoline and poor gas mileage, concerns about local air quality, limits on greenhouse gas emissions, and perhaps others yet unknown—competition to the gasoline car from new technologies will inevitably increase.

Gasoline engines now provide cheap, reliable transportation to billions of people. But gasoline engines also carry big disadvantages. They are noisy. Anyone in an urban or suburban area hears gasoline engines all day long—in cars, trucks, buses, scooters, lawn mowers and leaf blowers. Particularly on crowded urban streets or busy interstate highways, the noise of gasoline engines can be deafening.

And they are dirty. Even modern cars with complex emissions controls spew out pollutants until their catalytic converter warms up. And engines without those controls are hideous polluters. A two-stroke gasoline engine on a scooter reportedly puts as many unburned hydrocarbons into the air in one day of driving as a modern gasoline car puts into the air over 100,000 miles. Cities in China, Indonesia, Malaysia, Thailand and India have seen their air become smoke because of large numbers of two-stroke mopeds on the roads.

In the United States, California provides a good example of the problem. In California, car exhaust accounts for 90 percent of the state's carbon monoxide, 77 percent of its nitrous oxides, and 55 percent of its reactive organic gases.

On some days, ozone levels in Southern California can be three times the federal limit. In recent years, California's air has gotten cleaner, a result of stringent state regulations that prompted carmakers to build special pollution-controlled “California editions” of their cars.

The automobile emissions debate continues in the United States. Some claim the problem has largely been eliminated. Others claim that the problem continues to be serious. But both sides agree on some things. First, emissions do hurt the quality of the air. The biggest source of air pollution in a majority of the world's cities is auto exhaust. Second, most of the cheap and easy things that can be done technologically to lower emissions, at least in the United States, have been done.

Third, emissions are increasing around much of the world, especially in developing countries whose populations are falling in love with automobiles and enjoying industrial growth. In fact, growth in both populations and vehicle sales in the developed countries has started to decrease. Even so, the increase in the number of vehicles worldwide—a number that increased at least ten times between 1950 and 2000—continues to not just match, but to outpace the rapid population growth in the world as a whole.

Moreover, few dispute that an electric car, if viable and widely accepted, would greatly improve air pollution in major cities. Even the most advanced and expensive emissions systems cannot match the zero pollution of a propulsion system that does not rely on internal combustion to power a car.

With a billion cars, trucks, scooters, motorcycles and buses on the road, we need to take advantage of those efficiencies. Nothing can eliminate the impact on our environment of all those vehicles. But if we can eliminate much of the noise, the dirt, and the inefficiency, we should. That may make a big difference in the quality of the world that future generations inherit from us. Gasoline cars are inefficient. In fact, it is estimated that, depending on conditions, only about 7% to 18% of the energy in the car's gasoline actually moves the car. On average, only 12.6% of the energy in a gallon of gasoline makes it to the wheels, 62% being lost due to engine friction and heat losses. In stop and go city driving, acceleration is the biggest need, rolling is next, followed by aerodynamic drag. On the highway the order is reversed: aerodynamic drag, which increases at an increasing rate with speed requires the most energy (about 10.9%).

Ironically, the average fuel economy of U.S. cars is worse today than it was 14 years ago. The average for all passenger cars and light trucks sold each year fell from 25.9 miles per gallon in 1987 to 24 miles per gallon in 2001. Why? The hottest vehicles on the US market in 2003 are sport utility vehicles (SUVs), which account for 40 percent of all new car sales. These heavy, fuel inefficient vehicles decrease overall fuel efficiency and increase emissions.

Civilization is in no immediate danger of running out of energy, or even just out of oil. But we are running out of environment. That is, our environment is losing the capacity to absorb energy's impacts without risk of intolerable disruption. Our heavy dependence on oil in particular entails not only environmental but also economic and political liabilities caused by fossil fuels as they're extracted, transported, burned, and fought over.

Gasoline-powered vehicles received a boost from the fortuitous discovery of enormous amounts of oil in Beaumont, Tex., in 1901. The discovery came at a time when the demand for petroleum products was in severe decline (as gas and electricity displaced kerosene as an illuminant) and gasoline-powered vehicles were still a novelty (considered a potentially dangerous one) among automobiles.

But the advantages of gasoline as an energy-rich, easily portable fuel quickly made gasoline cars popular. Gasoline-powered vehicles now consume half the world's oil and account for a quarter of its greenhouse-gas emissions. In the United States, fuel economy stagnates while new-car registrations skyrocket and the number of miles the average motorist drives each year rises.

China is leading a Third World rush to “modernize” through the use of private cars. Some predict that over 400 million Chinese drivers will begin to drive gasoline-powered cars over the next 50 years. That number, together with many other large populations in India and other countries that are trying to modernize, will put tremendous pressure on the world's oil resources. To say nothing of the air pollution that will come from that many cars.

And, strange as it may seem in a period of exceptionally cheap gasoline, the end of the fossil fuel era is a real possibility. Many predict that demand could soon start to exceed supply. That problem could be exacerbated by the concentration of most remaining large reserves in a few Middle Eastern countries. (The recent wars in the Persian Gulf highlight the problem.) Some experts also say that the problem is worse than it appears, since the size of many countries' oil reserves has been systematically exaggerated for political and economic reasons.

A gasoline car requires regular maintenance, things from changing oil and oil filters to replacing timing belts. Repairs are frequent, and often costly. The typical gasoline car owner visits a mechanic or other service facility several times a year. Repairs typically take more than one day, while scheduled maintenance usually takes less than one full day.

The maintenance and repair often required for gasoline cars during their lifetime include the following:
Engine fuel sensors, air sensors, and other engine sensors needing replacement/repair
Engine tune ups; fuel injection system repairs
Oil changes and flushes; oil filter replacement
Air filter replacement
Muffler replacement; exhaust system repair (less common with new models)
Radiator fills and flushes; radiator leaks
Fuel pump replacement
Engine head gasket replacement
Water pump replacement
Transmission flush and repairs
Brake pad replacement; brake system repair
Timing and other belt replacements
Hose replacements
Smog tests
Scheduled maintenance every 15,000, 30,000 and 60,000 miles

Gasoline engines have become very complex. Just the different fluids required in a gasoline car make a long list: power steering fluid, brake fluid, transmission fluid, engine oil, gasoline, radiator coolant. A great deal of research and engineering has been done over the last 100 years to develop gasoline engines that are more powerful, more efficient, and less polluting.

Any car must have a body, chassis, passenger compartment, steering mechanism and other “user interfaces,” wheel and tires, and doors and windows. Gasoline cars also have the following systems to provide the necessary power to move the car:
Cooling System: Radiator, hoses, fan, fan belts, thermostat.
Fuel System: Gas tank, carburetor or fuel injector, filter, fuel lines.
Air Intake System: Air cleaner (optional turbocharger, supercharger, intercooler).
Engine: Engine block, pistons, piston rings, cylinders, cylinder head, gaskets, crankshaft, connecting rods.
Valve Train System: Valves, camshaft, timing belt.
Lubrication System: Oil pan, oil pump, oil filter.
Electrical System: Battery, alternator, voltage regulator.
Ignition System: Distributor, ignition wires, spark plugs, coil, timing belt.
Starting System: Electric starter motor, starter solenoid.
Transmission and Drive Train: Gearbox and clutch assembly or automatic transmission, universal joints, drive shaft, differential.
Exhaust System: Manifold, muffler, tailpipe.
Emission Control System: Catalytic converter, PCV valve, sensors, computer.

A gasoline engine harnesses the power from controlled explosions of a highly volatile and high-energy fuel: gasoline. Changing the energy in gasoline to rotary power at a car's wheels is a complex, inefficient process. The pressure generated by these explosions puts great mechanical stress on the engine block and the pistons. Much of the energy in gasoline changes to heat rather than rotary power. In fact, temperatures in the combustion chamber of an engine can reach 4,500° F. (2,500° C.).

With the extreme pressure and temperature in a gasoline engine, the engine block must be big and heavy. In addition to containing high pressures, an engine block must have areas for coolant to circulate. In particular, cooling the area around the cylinders is critical. Areas around the exhaust valves are especially crucial, and almost all of the space inside the cylinder head around the valves that is not needed for structure is filled with coolant.

To provide a strong enough structure to contain the high pressures, withstand high temperatures, and still provide internal holes for the cylinders and for coolant, engine blocks have been big, heavy pieces of steel. Bulk and weight also provide rigidity needed to reduce noise and vibration from an engine block.

Attempts have been made to use aluminum alloys, metal matrix composites, ceramic matrix composites, and ceramics such as silicon carbide to make all or parts of engine blocks, with some success. Improvements have been made, and are still possible. But the physics and chemistry of internal combustion put strict limits on the size, weight, and material strength needed for a gasoline engine.

Given the benefits of electricity as the driving force of a car—the efficiency, reliability, simplicity, quiet and cleanliness of electric motors—an electric car with an all-electric drive train would be desirable.

The advantages of electric cars have been known for a century. As Scientific American observed in 1896, “The electric automobile . . . has the great advantage of being silent, free from odor, simple in construction, capable of ready control, and having a considerable range of speed.”

That prompted one commentator to note, again in Scientific American, 100 years later in 1996 that “it seems certain that electric-drive technology will supplant internal-combustion engines—perhaps not quickly, uniformly, nor entirely—but inevitably. The question is when, in what form and how to manage the transition.”

Electric vehicles will not completely solve pollution problems from fossil fuels. Early fuel-cell cars may well run on these fuels. Parallel and some serial hybrid cars will burn them, though they will do it efficiently. And as critics point out, even “emission-free” battery-powered vehicles rely on electricity from utility-owned power plants that often burn oil or coal.

But electric cars will make a big difference in air pollution. Battery electric cars will produce no emissions. Not from the car at least. In traffic jams or waiting for stoplights, even many hybrid electric cars do not use power or produce emissions, unlike gasoline cars that waste fuel as they continue to run and produce emissions that can become choking to those stuck in their cars. That difference alone offers a huge advantage on the crowded freeways of Los Angeles and other major United States and international cities.

Although the power for a battery electric car still has to be generated from a source, centralizing power production in large electric plants rather than in small gasoline engines reduces air pollution and increases fuel efficiency. The fumes can also be dispersed from a tall stack or chimney rather than released near pedestrians. As an added bonus, this energy might be generated from more environmentally benign sources such as tidal, solar, wind, and hydroelectric power technology.

In fact, by some estimates, it would take more than 100 electric vehicles getting their power from a fossil-fuel-burning electric power grid in California to equal the volatile-organic-compound production of the typical new gasoline car, 5 to equal its nitrogen oxide production, and 100 to equal its carbon monoxide output.

Even parallel and series hybrid electric cars improve emissions control. In a series configuration, the engine can be decoupled from performance needs. That means emissions can be reduced in at least five ways:
1. Operate at a constant, optimal speed to minimize tailpipe exhaust per unit of energy input.
2. Engine transients can be avoided. Transients are thought to account for a substantial proportion of emissions.
3. The catalyst and exhaust treatment systems can be designed optimally for the pre-determined engine operating point to provide the best possible performance.
4. Engine starts can be anticipated without influencing vehicle operation. This permits the straightforward use of catalyst preheaters to reduce cold-start effects.
5. There are no emissions associated with idling conditions. The engine need operate only when its output can provide useful work.
   These gains are in addition to the advantages of a smaller engine and to the possible use of pure electric modes for short-range driving.

The reduction of noise pollution from electric cars may be even more dramatic. In electric cars where no part moves faster than the wheels, the car can move with virtually no noise. Only the noise of the tires on the road and some flexing of the body of the car will be heard, even as speed and power increase.

For many who first drive an electric car, its simple silence leaves the greatest impression. Were electric cars to gain a large percentage of the traffic on urban streets, the silence may be deafening. We worry about air pollution, but noise pollution has also become a great problem for modern societies. Electric cars can help greatly with that problem.

Electric motors have the potential to be much more efficient than gasoline cars. The United States government estimated that only about 20% of the chemical energy in gasoline gets converted into useful work at the wheels of a gasoline car, but 75% or more of the energy from a battery reaches the wheels of a battery electric car.

That big efficiency advantage has already been put to use by Honda and Toyota with their gasoline/electric parallel hybrid cars, which offer 40 to 60 miles to the gallon compared to the 20 to 30 for a comparable gasoline car. A battery only or series hybrid electric car with only an electric motor or motors in the drive train offers the potential for even more efficiency.

In addition to higher operating efficiency, electric cars can use regenerative braking. Regenerative braking potentially recovers about 20% of the energy used in the Federal Urban Driving Cycle.

Running cars on electricity opens up a host of new fuel options not based on oil, including renewable resources such as wind power and solar energy. Indeed, a significant advantage of electric cars over gasoline cars is the variety of sources for energy to run an electric car, particularly as a hybrid.

These range from the impractical—in 1894 one inventor proposed using the energy contained in stretched rubber bands to run an electric car—to sources that have actually been used to power electric motors or to stretch their range—gasoline or natural gas engines, overhead electric wires, inductive strips embedded in roadways, fuel cells, batteries, flywheels, hydraulic energy storage, and solar cells.

Many predict that fuel cells will replace gasoline as the preferred power source for cars within the next 20 to 30 years. If this occurs, those fuel cell cars will need to be powered by electric motors. The success of those fuel cell cars may well depend on the efficiency and performance of the electric motors driving them.

Most major carmakers have committed to making fuel cell-powered vehicles. Estimates on the time frame for reasonable numbers of production fuel cell vehicles to be sold range from 10 to 20 years.

Automotive industry leaders conclude that within 20 to 30 years, between 7 and 20 percent of new cars sold in the world will be powered by fuel cells. That may put a global fleet of 40 million fuel cell vehicles on the road by 2020. Some, including Ford's Chairman William C. Ford, Jr., expect fuel cell cars to pass gasoline cars as the dominant form of transportation by 2025.

“I believe fuel cell vehicles finally will end the hundred-year reign of the internal combustion engine as the dominant source of power for personal transportation. It's going to be a winning situation all the way around—consumers will get an efficient power source, communities will get zero emissions, and carmakers will get another major business opportunity—a growth opportunity.” William C. Ford, Jr., Ford Chairman, International Auto Show, January 2000.

Whether hope or hype, funds from both industry, government and private investors are flowing into fuel cell research, development and production. Even President George W. Bush of the United States has decided that fuel cell technology has proven itself as a “greener” alternative to gasoline engines. Now there is an intense international competition to commercialize fuel cell vehicles, and a race to make the technology affordable and appealing to the consuming public.

Some fuel cell vehicles operate on the roads even today in 2003. The largest technological obstacles to overcome appear to be cost, reliability and durability. Fuel cells are expensive, due to the use of high-tech membranes and platinum as a catalyst. They have reliability and durability problems. Even when stationary, fuel cells have a limited life. Fuel cells may prove too fragile over several years of the shocks and motion on a mobile platform like a car. And cold temperatures, like those of winters in the Northeast and Midwest of the United States, present a big problem for fuel cells.

Automakers recognize the problems that need to be worked out for fuel cells to be practical in a production car. Most have now said that production fuel cell cars will not be in car showrooms for at least 15 years. But most also believe that the problems with fuel cells will be solved, one way or another.

Electric cars still require maintenance and repairs. But with much simpler systems, and only one moving part in an electric motor, the wear and tear of dealing with explosive combustion are eliminated. In particular, the tribological (friction and wear), mechanical, chemical and thermal stresses that are so difficult to deal with in high power, high performance gasoline engines can be largely eliminated in an electric motor drive.

With current data, it is hard to compare the maintenance requirements of electric cars to gasoline cars. Not enough electric cars are on the road to make a good comparison. In fact, some of the few studies that have been done indicate that battery electric cars may require more maintenance and more frequent repairs than comparable gasoline cars. In addition, the time required for repairs may be greater than for gasoline cars.

While nothing can be taken for granted, many high-powered electric motors have been used in mobile applications for years. Experience with electric motors in high-speed trains, electric buses, subways, and other vehicles has proven them to be much more reliable and easy to maintain than gasoline or other internal combustion engines.

In addition, the major carmakers have started to take their parallel hybrid cars to production. One carmaker reported that it had no durability, reliability or quality issues with their electric motor systems. In its opinion, such problems are unlikely, since high volume helps electronics because it tends to make them better.

Based on this experience, most experts predict that, apart from battery replacement, no regular maintenance will be required for the power train and related systems of an electric car. That means no oil changes; no 15,000, 30,000 and 60,000-mile service; and no tuneups. In addition, the complex engine system and subsystems of a gasoline car simply are not needed in an electric car. Many of the auto parts that a typical car owner is familiar with needing to replace are simply missing in an electric car.

Electric cars will certainly have problems and need to be repaired. Just like gasoline cars, in some cases accidents will damage the propulsion system, and in other cases an electric car will stop running due to a failure and will need to be fixed. But there seems to be no question that eliminating the powerful gasoline engine in a car solves many maintenance and repair problems that cannot be eliminated in any other way.

Modern gasoline cars have evolved into very complex machines. Gasoline engines and their related subsystems to produce 100 to 400 horsepower incorporate a great deal of research and engineering. Translating that power to rotate the wheels of the car also requires sophisticated systems. Most of these systems can be eliminated in an electric car.

In particular, the drive train of a rear-wheel-driven gasoline car usually has an engine, clutch, transmission, propeller shaft, differential gears, half shafts and wheels. This complexity is necessary to convert the engine output (which can vary in speed between 800 and 8,000 rpm) into the zero to 1,500 rpm speed range required at the road wheels under normal operating conditions. The drive train must also accommodate the difference in inner and outer wheel speeds during cornering, and the wide range of power output required.

With an electric car, although it is possible to simply replace the gasoline engine by an electric motor, this would not take advantage of many of the characteristics of electric drive. In particular, the ability to start from zero speed makes it possible to eliminate the need for a clutch, and the available speed range is sufficient to not require the use of transmission gears. But the use of planetary gears, which allow the motor to run at much higher speed for a given road speed, may add considerably to the efficiency of the complete power train for some applications.

Any car must have a body, chassis, passenger compartment, steering mechanism and other “user interfaces,” wheel and tires, and doors and windows. But in an electric car, while the electrical system becomes much more complex, most of the following gasoline car systems are not necessary:
Cooling System: Radiator, hoses, fan, fan belts, thermostat.
Fuel System: Gas tank, carburetor or fuel injector, filter, fuel lines.
Air Intake System: Air cleaner (optional turbocharger, supercharger, intercooler).
Engine: Engine block, pistons, piston rings, cylinders, cylinder head, gaskets, crankshaft, connecting rods.
Valve Train System: Valves, camshaft, timing belt.
Lubrication System: Oil pan, oil pump, oil filter.
Ignition System: Distributor, ignition wires, spark plugs, coil, timing belt.
Starting System: Electric starter motor, starter solenoid.
Transmission and Drive Train: Gearbox and clutch assembly or automatic transmission, universal joints, drive shaft, differential.
Exhaust System: Manifold, muffler, tailpipe.
Emission Control System: Catalytic converter, PCV valve, sensors, computer.

Instead, an electric car powered by an AC induction motor will have some or all of the following systems.
Batteries
Controller
DC/AC Converter
DC/DC Converter
Electric Motor
Regenerative Braking Alternators
Miscellaneous Electronics
On-Board Charger (optional)

The development of low-cost, high-strength, permanent magnet materials and effective cooling methods has resulted in low-cost, lightweight electric motors suitable for vehicle propulsion. Both AC and “brushless DC” motors that are small and highly rated have been designed for electric propulsion, and those small but powerful motors make electric vehicles practical.

“Brushless DC” motors, which in spite of their name are actually AC synchronous machines with a DC/AC converter, have emerged as the motor of choice for the parallel hybrid cars of Toyota and Honda. Some US carmakers still favor AC induction motors. Table 1 shows the motor weight of some common motor types.

TABLE 1
Weight for a 45 kW motor using different machine technologies.

| Motor Type | Motor Weight (kg) |
|---|---|
| Wound field brush | 130 |
| Induction | 80 |
| Switched reluctance | 80 |
| “Brushless DC” | 45 |

Power to motor weight ratios for the best-performing gasoline engines exceed the numbers for electric motors. And while gasoline engines require bulky, heavy subsystems to support them, so do electric motors often require bulky, heavy batteries. On balance, though, electric motors will be superior in terms of the overall size and weight required to produce a certain amount of power.

If battery purchase and replacement costs are disregarded, the cost for recharging battery electric cars will be lower than the cost for refueling with a comparable amount of gasoline. Comparisons are hard to make. But with the efficiency of electric motors, compared to gasoline engines, some estimate that the fuel cost for an electric vehicle with lead-acid batteries charged at the average electric power prices in 2003 in the United States will be as high as 85% lower than the fuel cost for the average gasoline car.

One study that used a 3.3 miles per kilowatt hour figure for a battery electric car found that electricity costs would be about 67% lower than for the fuel cost for the average gasoline car. Improvements in the efficiency of electric motors and battery charge/discharge efficiency may well reach or exceed the 85% less cost cited above.

Moreover, most battery electric car recharging may occur mostly at night, at lower rates. Power companies have a large amount of underutilized capacity at night. The Electric Power Research Institute has reported that U.S. electric utilities have enough capacity to support up to 20 million electric vehicles on nighttime charging, without having to construct new power plants. The net result of using this capacity would be lower electricity prices, higher utility profits, or both.

Of course, the pricing of electricity may well change if large numbers of electric cars come to be charged at night, or at charging stations away from home. The turmoil in the California electricity market due to deregulation shows how sensitive the pricing of electricity can be to social and political changes. But given the efficiency of electric motors compared to gasoline engines, there does seem to be a real difference in fuel prices that will persist.

And it is not hard to see how using an electric motor in a parallel hybrid like the Toyota Prius and the hybrid Honda Civic have lowered fuel costs. In both cases, the fuel cost per mile have been cut by about 50%.

Having an electric motor in the drive train of a car continues a century-old trend:

the electrification of the car. In 1912, Charles Kettering and his colleagues designed and built all-electric starting, ignition, and lighting systems for automobiles. That trend is accelerating.

In fact, it is now estimated that the cost of the electronics in a new car rises by 9 to 16 percent each year. In the 2001 model year, electronics accounted for 19 percent of a mid-sized vehicle's cost. In the year 2005, it may be 25 percent for mid-sized cars and possibly 50 percent for luxury models.

Electrification of the gasoline car reached new levels with the Toyota and Honda hybrid cars of the late 1990s and early 2000s. For the first time, a large number of production cars have an electric motor in the drive train. And Toyota announced its plan to have an electric motor in the drive train of all of its cars by 2012.

The increased use of electronics in cars makes possible total energy management strategies that cannot be used with a gasoline engine in the power train. An all-electric car allows all systems to be integrated under a central controller, for maximum efficiency.

Many direct wheel drive prototype vehicles have been made. One of the earlier (1994) examples of a functional direct wheel drive electric vehicle was the Di-Elettrica, a motor scooter with a direct drive rear wheel. The Di-Elettrica was powered by a slotless axial flux permanent magnet DC motor with a single disc shaped stator sandwiched between two permanent magnet disc rotors. The motor was mounted inside the rim of the scooter's drive wheel.

Another motor arrangement had a stator of a permanent magnet disc motor attached to the sprung body of the vehicle, with the rotor attached to the unsprung drive wheel shaft. This arrangement further reduces the unsprung mass of the vehicle, but requires a relatively complicated and dynamic control strategy to accommodate motor torque fluctuations due to constant and variable rotor-stator misalignment associated with vehicle suspension movement.

Other motors have been specially designed for direct in-wheel use. Several examples exist of permanent magnet motors designed and optimized for placement in the hub of an electric vehicle drive wheel. Ultimately, most believe that the best configuration is to mount geared motors, or even gearless motors, in the drive wheels of an electric car. GM would like to use hub motors in its Autonomy concept car, but has found current hub motors to be too heavy.

If an electric vehicle is to operate efficiently and effectively, it is essential that the total vehicle system be optimized at all times to ensure that the energy available is used as effectively as possible. The amount of energy available is normally much less than that in a gasoline-powered vehicle. But the performance needs to be comparable if the electric vehicle is to operate on the road system at the same time as conventional vehicles.

In the early days of electric vehicles, only the electric motor speed and torque were controlled. This was done by switching batteries in and out to give coarse voltage control and by variation of field and armature resistance of the DC motors universally used at that time. These control techniques were adequate to make the early electric vehicles developed competitive. But once the internal combustion was fully developed in the first decade of the 20^{th} century, the performance of vehicles using this form of propulsion was so much improved that electric vehicles ceased to be of any interest.

When electric vehicles appeared again in small numbers in the 1960s, the early methods used for the control of DC motors were still in use. Gradually the early methods were superseded by “chopper” circuits as transistor technology developed in the 1970s and 1980s.

Many of these simple control systems are still in use, but in recent years it has been recognized that if electric vehicles are to fully exploit their zero-emission advantage they will have to compete more effectively on performance with conventional vehicles. To achieve this, it is clear that every aspect of the vehicle will have to be carefully controlled.

Electric cars can employ a sophisticated electronic energy management system using complex software to use the often limited energy available in the most efficient way possible. The typical microprocessor control system makes use of a range of inputs from sensors measuring battery, motor, vehicle and ambient conditions. It combines this information with driver-demand inputs from braking, steering, accelerator and the various switch controls available.

Then, using electronic models of the vehicle and the battery held in memory and optimizing for the best energy usage, outputs are generated by the microprocessor to continuously control motor torque and speed, gearing ratio (where changeable gearing between motor and drive wheels is used), regenerative braking, external lighting, heating, ventilating and air conditioning.

When the vehicle is stopped and plugged into a charging station, the microprocessor will monitor the battery, generate the charging algorithm, and control the charger. In the most sophisticated systems, navigational information can also be held in memory of the microprocessor and be processed by it to provide navigation instructions to the driver.

Information on the vehicle and battery condition and the way it is being driven can also be generated. This information can then be held in reprogrammable memory. This enables the driver to obtain information on the distance remaining before the battery will require recharging if he continues to drive in the same way. The driver may also be alerted to any functional problems with the vehicle. The system also provides information for the driver instruments showing speed, distance traveled, state of charge, miles to battery “empty” (normally considered to be at 20 percent state of charge), charger in operation, and inside and outside air temperatures.

The comprehensive energy management system will need to control all the auxiliary systems in the vehicle including lighting, de-misting, de-icing and seat heating. These often operate from a much lower voltage than that of the main battery both for safety reasons and to permit standard components to be used. Currently these systems require 12 V, but increasingly designers are suggesting a move to a 42 V power supply for these systems even in conventional cars.

Low voltage operation will also be used for all the small motors,and solenoids used around the vehicle for door locking, window opening, seat adjustment and other convenience functions. The air-conditioning compressor will, however, operate at full main battery voltage to avoid the conversion losses that would occur if such a high power system were operated at low voltage.

The configuration and complexity of both the electronic controller and the power electronics in any control system are affected by a number of factors, not least of which is the number of motors to be used. A typical electric car design has one, two, or in the case of in-wheel motors, four motors. More than one motor effectively excludes the use of gear changing as a method of optimizing efficiency, as the complexity is too great.

Typically, the use of two drive motors requires the use of separate power driver circuits and separate fixed ratio planetary gears for each motor. This ensures that it is possible to adjust the torque between the two motors when the vehicle is cornering so that it is reduced on the inner wheel and increased on the outer. There is also a potential problem if power is lost to either motor as the vehicle could veer to one side and the control system must be programmed to take care of this, since it is a significant safety issue.

Other factors affecting control-system complexity include the use of a gearbox which requires electronic control if energy transfer between the motor and the road wheels is to be optimized. The power electronics switching must be controlled when reverse rotation of the drive motor or power regeneration during braking is required.

One of the most promising direct wheel drive configurations for electric vehicles is the four in-wheel drive electric vehicle. Incorporating a motor in each wheel increases the number of drive motors in the vehicle, thus decreasing the required power and mass of each individual drive motor. Four in-wheel drive vehicles require a distributed control system that can deliver the appropriate control to each individual drive motor.

Although this need for a distributed control system may at first seem like a drawback, it should be noted that conventional four-wheel drive systems also require a relatively complex control system to regulate the performance of the drive train. In addition, a modern conventional four wheel drive train and transmission system is quite complex mechanically and very expensive to manufacture. The complexity required to implement control in an electric four in-wheel drive system can be reduced to programming a micro-controller chip.

New application specific motor topologies will continue to be developed. The line between motor design and motor control is becoming less distinct. As computer and power electronics technologies continue to advance, motor designs that take advantage of new control options are becoming more common. This blending of mechanical electrical design and control technology will offer new opportunities for motor designers, technology experts and control theorists to work together to develop more robust and efficient electric vehicle drive systems.

In Japan, Europe, the United States, Canada, and many other countries, governments have encouraged research and development of electric cars. Some governments provide tax incentives for consumers to buy electric cars and other vehicles. The power of the oil and carmaker lobbies in the United States cannot be ignored. But electric cars do tend to draw political support.

All kinds of electric motors can operate as generators if their control circuits are suitably designed. That makes regenerative braking possible in most electric cars. In fact, regenerative braking was used for the first time in an electric coupe demonstrated by M. A. Darracq in Paris in 1897.

Many modern electric cars also use regenerative braking. Allowing a car's wheels to mechanically overdrive a motor can turn it into a generator. Sufficiently loading the motor/generator can produce a powerful braking force on the wheels.

To be effective, regenerative braking must be applied over the whole range of operation of the car, and the mechanical brakes only sued as a safety backup. When used under these conditions, it is essential to avoid overheating of the motor.

It is also important that the battery is capable of absorbing the returned energy at the highest required level. This may be a problem with some battery types, in which case the facility to switch automatically to dynamic braking is which the energy is dissipated to resistors instead of being returned to the battery may be necessary.

In energy terms, it is difficult to recover by regenerative braking much more than about 10% to 15% of the total energy used in propelling the car. But in view of the severe limits on range in electric cars, that may be well worthwhile.

For many years, the major carmakers focused only on gasoline engines. Slowly, though, the technology for merging electric and gasoline vehicles started to arise, with on-board computers, new materials, and new ideas.

The combination is ideal in many ways. Electric motors have very high torque, to get a car rolling almost immediately. Gasoline engines are more efficient when running at a constant speed (e.g. to produce electricity). If you use electric power, you can generate it while braking, recapturing energy otherwise lost as heat.

Now, nearly every carmaker is working on hybrid systems. Toyota and Honda have led the way to production with their parallel hybrid cars, the Toyota Prius and the Honda Insight and then Prius. A parallel hybrid combines a gasoline engine with an electric motor in the power train.

The result is a vehicle powered by a gasoline engine, in that it's the engine that drives the wheels or drives the generator that supplies (either directly or through the battery) the electric motor. But the engine is only as big as it needs to be. It isn't even running all the time, and if sudden acceleration is called for, both the gasoline engine and electric motor share the load.

The engine in hybrid vehicles like the Prius run exclusively on gasoline, while the electrical portion of the power system never needs to be plugged in for a charge. There's no cord and no waiting. You can fill up at any normal gas station anywhere.

But the real benefit, to both the owner and driver of a hybrid like the Prius, and the environment, is in the numbers. The Prius is roomy enough inside to meet the EPA's Midsize category, just like the Toyota Camry. It accelerates from 0 to 60 mph in about 10 seconds (roughly equal to a four-cylinder Toyota Camry), and delivers fuel economy in the mid-50-miles-per-gallon range.

That makes the Toyota Prius the most fuel efficient of any midsize vehicle sold in America. And it delivers twice the combined mileage rating of its closest competitor. In addition, the Prius has been certified as an SULEV, or “Super Ultra Low Emission Vehicle.

The 2004 Toyota Prius probably qualifies as the most sophisticated production hybrid today. The 2004 Prius has a 1.5-liter, four-cylinder gasoline engine of 78 horsepower. That engine is linked to drive the wheels directly via a transmission and, whenever the engine is running, it also drives a generator that keeps the battery charged. The generator supplies electrical power to the electric motor or the battery, as needed.

Whenever the Prius is stopped, the gasoline engine is shut down. This means no unnecessary idling or fuel waste while stuck in traffic or at stop signs. When accelerating from rest at a normal pace, and up to mid-range speeds, the Prius is powered by the electric motor, which is fed by the battery.

As the battery charge is depleted, the gasoline engine responds by powering the electric generator, which recharges the battery. Once up to speed and driving under normal conditions, the engine runs with its power split: part of this power goes to the generator, which in turn supplies the electric motor, and part drives the wheels.

Switching power from the gasoline engine to the electric motor and back is a difficult process. A New Yorker cartoon has a car salesman explaining a parallel hybrid to an interested couple this way: “It runs on its conventional gasoline-powered engine until it senses guilt, at which point it switches over to battery power.”

In reality, the distribution of these two power streams from the engine is continuously controlled to maintain the most efficient equilibrium. If the need arises for sudden acceleration, such as a highway passing maneuver or a quicker start from rest, both the gasoline engine and the electric motor drive the wheels.

And during braking and other types of deceleration, the kinetic energy of the moving vehicle is converted into electrical energy, which is then stored in the battery. At all times the state of charge of the battery is constantly monitored, and whenever needed the generator is powered by the gasoline engine to provide the necessary charge.

Like a parallel hybrid, a serial hybrid also has both a gasoline engine and an electric motor. Rather than have the gasoline engine in the drive train, though, only the electric motor drives the wheels.

One familiar serial hybrid is the diesel-electric railroad locomotive. These have huge diesel engines, which drive generators, which supply the electrical power for electric motors, which in turn drive the wheels. The diesel engine operates within its most efficient speed range, and varying the speed of the train is done through the electric motors. This makes for a very fuel efficient, and reliable, power train.

But of course, once trains are up and running they tend to run at fairly constant speeds anyway. The varying conditions in the typical driving cycle of a car make serial hybrids face some challenges. Possibly for this reason, no serial hybrids have found their way into production, or even onto the near horizon.

Another advantage of electric motors is their ability to provide power at almost any engine speed. While internal combustion engines must be revved up to high rpm to achieve maximum power, electric motors provide nearly peak power even at low speeds. This gives electric vehicles strong acceleration performance from a stop. These and other characteristics of electric motors provide performance that gasoline engines cannot match.

### Problems with Electric Cars

“The electric car is the future of transportation.” This statement is as true today as it was when it was made, in 1899. Electric cars are naturally clean, quiet, and most of all, efficient. But why haven't electric cars ever fulfilled their promise? Why is almost every car on the road today powered by a gasoline engine?

The market has proven time and again that electric cars which do not offer the same or better performance at the same or lower cost will not wean us away from our gasoline cars. That creates, therefore, the strong need for an electric car that is competitive with, or superior to, a gasoline car.

1. Limited Range

Most experts believe that the main drawback to electric cars is their limited range. Even early in the 1900s, car buyers chose gasoline cars over electric cars mainly for the ability to go “touring” through the country. Some experts believe that car buyers will insist on a minimum range of about 250 miles before recharging. Current battery technology has not come close to that range without meeting barriers of the cost, size and weight of batteries.

Because electricity is not easily stored or transported, the major issues electric vehicles face are range (miles driven on a single charge) and recharge time. Range is complicated by cold or hot weather, hills and other vehicle power requirements, such as defrosters and air-conditioners. Battery range varies from less than 100 miles (lead-acid) to approximately 200 miles (nickel-metal hydride, zinc-air, lithium-ion).

Recharge time also varies widely. A full recharge may take from three to six hours, although some technologies can achieve a significant recharge in as little as 15 minutes (nickel-based). All in all, though, battery electric cars remain unpopular and a niche market largely, in the view of most experts, because the range and recharging problems have not been solved.

For this reason, parallel hybrids and fuel cell vehicles—which do not have a range problem—receive a lot of attention by carmakers and politicians. Battery only electric cars seem almost to have been abandoned by the major carmakers and any but a loyal, but small, group of electric car enthusiasts.

2. Heavy, Bulky, Expensive Batteries and Cars

Right now, the weak link in any electric car is the batteries. Batteries have six significant problems that must be balanced against each other. Applied to a typical lead acid battery pack for an electric car, these problems are:
Weight (a typical lead-acid battery pack weighs 1,000 pounds or more)
Bulk (some cars have up to 50 batteries, each measuring 6″ by 8″ by 6″)
Limited capacity (often as little as 12 to 15 kilowatt hours of electricity, for a typical range of only about 50 miles)
Slow to charge (typically four to ten hours)
Limited deep discharge/recharge cycle life (300-500 cycles)
Short life (typically three to four years)
Expensive (about $2,000 for a lead-acid battery pack, the cheapest kind).

Cost differences among battery technologies are largely a trade-off of higher up-front costs for batteries that offer longer life cycles and faster recharging times than less expensive technologies. For example, in the above example, more expensive nickel metal hydride batteries can be used in place of the lead-acid batteries. The range of the car will double and the batteries will be about three times as long. Cost will also be 10 to 15 times higher.

Prices for advanced batteries like nickel metal hydride and lithium-ion may fall as these batteries improve and become more used. But in general, all battery technologies for vehicles are still far more costly than today's internal combustion engine and are a major drawback to electric vehicles competing in the mass market.

One comparison shows the real problem. Two gallons of gasoline weighs about 15 pounds, costs about $3.00, and takes only about half a minute to pump into a tank. The equivalent of these two gallons of gasoline is 1,000 pounds of lead-acid batteries that cost $2,000 and take four to ten hours to recharge.

Battery weight and volume tend to cause major problems in electric car design. Weight significantly affects any vehicle's performance. This causes a particular problem in electric vehicles whose only source of power is the battery.

To obtain a minimum acceptable range of 100 km with a typical small electric car currently requires over 400 kg of lead-acid batteries, about 200 kg of nickel-metal hydride (NiMH) batteries, or about 120 kg of lithium-ion (Li-Ion) batteries. This assumes that the battery is fully charged at the start and is discharged to the lowest practical level of 20 percent state of charge (“SOC”) by the end of the journey.

A typical electric car design has a lead-acid battery and its associated electric motor and controls. All told, the battery, motor and controls weigh about twice as much as the equivalent internal combustion engine, drive train and fuel in a conventional car. The weight and cost of these components, coupled with the range limitations for a battery-only electric car, spelled the commercial doom of the battery-only car both in the past few decades as well as in the early 1900s.

There is, moreover, a compounding effect of this additional weight. Stronger and therefore heavier structural components must be used to support the concentrated battery weight and provide adequate crash protection. As a rough rule of thumb, for each additional kilogram of subsystem weight at least 0.3 kg of structural weight must be added. This results in an overall increase in the curb weight of the vehicle of about 20 percent and a corresponding loss of performance.

This increase is reduced or eliminated when advanced batteries are used, but only if the same limited range, as is unavoidable with the lead-acid-powered vehicle, is accepted. If advantage is taken of the better energy density of the advanced batteries to use more batteries and increase range, the weight disadvantage of electric drive is not eliminated.

Specially designed electric vehicles—using lightweight materials, improved aerodynamics and sophisticated electronic controls—can produce vehicles with comparable performance to their gasoline engine equivalents. But this cannot remove the severe range limitations caused by the low energy density of batteries compared to that of gasoline.

Large battery volume causes another major problem in electric vehicle design. A tank of gasoline contains more than 100 times the useful specific energy per kilogram of a lead-acid battery. Gasoline contains more than 20 times the useful energy density per liter of volume. Thus, both the weight and volume of batteries must be much larger than the fuel tank of a conventional car.

In practice, this has meant that many electric cars can carry only two people because of the space required for batteries. Advanced batteries improve this situation to some extent. Typically, nickel metal hydride batteries currently require 40 percent less volume than lead-acid and lithium-ion over 60 percent less for the same stored energy. Lithium-ion batteries have a further advantage in that they can sometimes be formed into different shapes using flexible foil construction.

Designing for minimum weight and volume tends to drastically increase the cost of vehicle designs. For example, the Honda Insight has advanced aluminum components and ABS composites to reduce body weight by 40 percent over a comparable steel body. Similarly, Honda claims to have achieved a 30 percent reduction in the weight of the internal combustion engine used, by using special construction of engine block and connecting rods, and using aluminum, magnesium and plastic for engine components.

This advanced engineering adds greatly to cost. Those manufacturers who currently produce production hybrids (notably Honda and Toyota) have to subsidize the true cost of their hybrid vehicles by more than 50 percent to bring the cost down to a level at which the general public will be prepared to lease or buy.

3. Low Power

One drawback to electric cars has been a lack of power for accelerating from a stop and for passing. Because of the problems of weight, battery power production rates, and other issues limit many battery electric cars to zero to sixty mile per hour speeds of 12 to 20 seconds. That has been slow enough to make electric cars unattractive to many consumers.

4. Low Efficiency Over Changing Conditions

Electric motors can be designed to operate very efficiently within a limited range of speeds. Outside of this range, they quickly lose efficiency. So while electric motors can be over 80% efficient in ideal conditions, over the typical varying driving cycle the efficiency of electric motors may fall to less than 50%.

These differences in efficiency between types of electric motors can be very high. Because compromises are so difficult to avoid, one attempt to make a practical electric propulsion system for a car, U.S. Pat. No. 5,549,172, goes to the extreme of using two motors in the car.

That invention recognizes that no existing motor performs well over the whole range of car operating conditions. Accordingly, that invention tries to upgrade overall system performance by combining a highly efficient motor at low speeds with a highly efficient motor at high speeds. The obvious disadvantage is the need for two complete, separate electric motors.

5. Problems with In-Wheel Motors

Many car designers believe that in-wheel, or “hub,” motors provide the best architecture for electric cars. Putting an electric motor in the wheel gives direct drive of the wheel, without the need for any power train. It also reduces the amount of space occupied by the electric motor. But putting a heavy motor in a wheel increases unsprung mass, which can be a key factor in a car's handling.

Direct drive wheel systems consist of a motor drive coupled directly to a driven wheel without any intervening gear or suspension linkage. As a result, there is a direct one-to-one correspondence between the rotation of the motor drive and that of the driven wheel.

This arrangement simplifies the drive train considerably but alters the suspension characteristics of the vehicle. In a conventional drive system (electric or internal combustion), the only unsprung mass in the vehicle are the wheels and a small portion of the drive train. Generally, the drive motor(s) in a direct wheel drive system are part of the vehicle's unsprung mass.

Most electric motors and all internal combustion engines are too heavy to be removed from the body of the vehicle and incorporated into one or more of the drive wheels. In order for an electric motor to be suitable for use in a direct wheel drive system, it must have a relatively low mass and a high torque to mass ratio. In addition, direct wheel drive motors must have physical dimensions that are amenable to location near or in a drive wheel.

Too much weight in a car's wheels will have several effects on suspension and ride. The higher the vehicle's unsprung weight, the more force with which the suspension's springs will compress and extend under hard cornering or over bumps. This causes excessive movement in the suspension, which produces a poor ride and reduces cornering grip. In addition, higher unsprung weight requires stiffer shock absorbers to control the extra spring movement, which also contributes to a stiff, harsh ride.

This problem may not seem great. But the effects are substantial and difficult to overcome. For this reason, General Motors has questioned whether hub motors will be practical in its Autonomy concept car.

6. Problems with Serial Hybrids

Using a gasoline engine as a power source to generate electricity for an all-electric drive train can solve the range problem that battery electric cars face. But serial hybrid cars weaken the advantages, and bring along some of the disadvantages, of both gasoline engines and electric motors. For example, a gasoline/electric hybrid car will still cause pollution. That makes it ineligible for electric-only zones.

A series hybrid vehicle requires both a gasoline engine and an electric motor on board the car, adding weight, taking up space, and most importantly, adding cost. Having a gasoline engine in the car, even if only to generate electrical power, may require many gasoline engine subsystems to be retained. Perhaps no juggling of the two systems will allow a design that matches the advantages of both, or that will make the complete vehicle as cheap as a vehicle with only one system.

Another problem with a series hybrid car is the weight. The car has to carry the weight of the electric motor, the generator, the gasoline engine and the batteries. Not as many batteries are needed as in a battery electric car, so that saves some weight. But a full-size electric motor plus a 10-kilowatt generator can weigh several hundred pounds.

Electric utilities dislike serial hybrids because they do not draw power from the electric grid and thus do not provide any new business. And oil companies are not excited about cars that can get 80 miles to the gallon or more. Finally, engineers often find hybrids conceptually interesting but practically too complex.

7. Problems with Parallel Hybrids

Parallel hybrid cars require complex control systems and control algorithms. The gasoline engine must be efficiently matched with one or more electric motors as driving conditions change. In addition to requiring two separate systems in the same car—a gasoline engine and one or more electric motors—those two separate systems must be made to work together.

Integrating a gasoline engine and electric motors under a single hood creates complex engineering problems. As one engineer noted about parallel hybrids, “It sounds simple. Try building one. It's not as easy as people think.”

In addition, when there are two propulsion systems it is going to be expensive. Increased volume does greatly reduce prices. But the prices to manufacture parallel hybrids are very high. Much higher than many people think. The production hybrid cars currently (in 2003) on the market from Honda and Toyota are being sold at about half their true production cost.

Some believe it unlikely that this situation could improve. Even with quantity production, these parallel hybrids may not be truly price competitive with either conventional gasoline cars, or if they become available, with battery-only electric cars using low-cost advanced batteries.

The objective of parallel hybrids is generally to minimize fuel consumption, but this may be modified by the need to provide a certain minimum range when only electric power is used to meet zero-emission requirements. The major problem with hybrid electric vehicles is the cost of giving two propulsion systems and some find it difficult to see how this can be overcome.

Politically, hybrids are appealing. Technologically, they could be seen as orphans that no one wants to adopt. Carmakers have mixed emotions about hybrids, which still require factory retooling. Toyota and Honda both have adopted the concept, at least as far as electric assist goes. In fact, Toyota announced its plan to have an electric motor in the drive train of all of its cars by 2012. DaimlerChrysler executives, on the other hand, totally dismiss hybrids as a waste of time, claiming that their new diesel engines have superior potential in both range and emissions control.

Finally, parallel hybrids still do not get exceptional fuel efficiency on the short trips that are very common for most drivers. Some experts estimate that for city and suburban drivers, about 50% of all trips are less than 3 miles.

But the fuel efficiency of a parallel hybrid car suffers during the first five minutes of driving from a cold start because of the way it controls emissions. (Cold starts also reduce the effectiveness of emissions control, leading to the release of many pollutants before the system warms up.)

Translating this into figures, the 2004 Toyota Prius has fuel efficiency of 51 miles per gallon for highway driving and 60 miles per gallon for city driving, as certified by the United States Environmental Protection Agency. Often, the typical city or suburban driver using the car will get much less, because of frequent short trips.

One test user found that he averaged only about 42 miles per gallon in combined city/highway driving. On his five-mile commute to and from work, he averaged only 31 miles per gallon.

8. Dangerous Voltages and Currents

Typical designs try to use a high battery-system voltage in order to reduce the amount of current that must be switched by the power electronics, and to reduce the losses due to voltage drops in the power elements. But safety considerations tend to limit the voltages used. The range of voltages used in most electric cars lie between 200 V and 350 V, although there have been proposals to use over 500 V for special vehicles.

Safety is particularly related not only to crash performance of the vehicle but also to the protection of the operator and service personnel from the high voltages (200-350 V) used in the battery, motor and control system. Trying to meet the high power requirements of an electric car forces a Hobson's choice between high voltages or high currents. Neither are easy to handle.

9. Complex Controls Required

Obtaining efficient operation of the vehicle propulsion motors and coordinating this with the effective operation of both pure electric and hybrid vehicles requires sophisticated electronic controls. These controls must be able to be adapted to a wide range of operating conditions.

At the same time, they must optimize the efficiency and economy of what may be a very complex system. In particular, motor control and regenerative braking is entirely dependent on the electronic controls and the power electronics operating together as an integrated system.

Electric vehicles must be designed to meet special requirements for maximum efficiency and safety. Efficiency is particularly important because of the relatively small amount of energy that can be stored in a battery compared to that stored in a gasoline tank. Some have tried to obtain high efficiency by minimizing weight, reducing rolling resistance by the use of high-pressure tires and designing the vehicle body for minimum air resistance.

The growing reliance on software for this control raises some issues. As every computer user knows, software is far more likely than hardware to fail, and rebooting is hardly practical in driving conditions such as a sharp downhill turn. Then, too, a car's software modules must communicate and coordinate with one another. That may also cause problems of safety and reliability.

The United States has a bewildering variety of regulations, established carmakers, and litigious customers. That makes it hard to introduce complex control schemes that have not been tested by time. Electric cars depend on electronics. But they are not like computers. A bug in a computer program causes annoyance. A bug in the brake system of an electric vehicle could cause death. That raises the stakes.

Designing for minimum weight and volume tends to drastically increase the cost of vehicle designs. For example, the Honda Insight has advanced aluminum components and ABS composites to reduce body weight by 40 percent over a comparable steel body. Similarly, Honda claims to have achieved a 30 percent reduction in the weight of the internal combustion engine used, by using special construction of engine block and connecting rods, and using aluminum, magnesium and plastic for engine components.

This advanced engineering adds greatly to cost. Those manufacturers who currently produce production hybrids (notably Honda and Toyota) have to subsidize the true cost of their hybrid vehicles by more than 50 percent to bring the cost down to a level at which the general public will be prepared to lease or buy.

This subsidized price has helped ensure that there are significant numbers of hybrid vehicles in the hands of the US public (as well as in Europe since 2000 and Japan since 1998). Most owners appear pleased with their performance.

However, production cost for these hybrids have not been reduced to a level at which the carmaker can make a profit (a significant challenge with effectively two propulsion systems on each vehicle). Until the cost has been greatly reduced, it is difficult to see how large numbers of hybrid vehicles can be sold and the environmental advantages of using them realized.

With battery electric cars, the high cost of batteries keep prices high. As their production picks up, the prices of electric cars may fall. Certainly that happened with gasoline cars. One expert believes that full-scale production could reduce the cost of electric cars to well below half the current level. Some analysts believe that electric cars will be competing with gasoline-powered cars, without subsidies, within a decade.

While that may be true, prices for electric cars remain high. It may be that no market for electric cars develops until prices come down. And prices may not come down until a market develops. That will leave electric cars limited to the niche market they currently occupy.

In the 1890s, electric cars were poised for success. At the New York auto show in 1900, more electric cars were displayed than any steam- or gasoline-powered vehicles. By 1910, wealthy families often owned several cars, with at least one electric.

The electric car gave women, in particular, freedom of travel, as it was easy to handle and caused none of the frequent scraped knuckles, or even broken arms, from manual starter-cranks in early gas engine cars. Advertisements lauded the clean, quiet motors, compared to the smell and noise of horses and gasoline cars.

By 1920, however, consumers had turned away from electric cars. Compared to the cheap, powerful gasoline cars with practically unlimited range, electric cars seemed expensive, underpowered and most importantly, severely limited in range.

Expensive, small, cramped, slow and stodgy electric cars with limited range have proven that “green” consciousness and conserving natural resources are sales points that appeal to only a small fraction of the consuming public. Similarly, converting gasoline cars to electric drive has been a thriving cottage industry for a few small companies and hobbyists. But those conversions have shown no signs of gaining anything more than a tiny sliver of the automotive market.

Electric cars have difficult problems in colder and hotter climates, particularly colder climates. The cold winters of much of the Northeast and Midwest of the United States, and parts of Canada, drain much of the power from electric batteries. While there are solutions to the problems caused by severe cold, none of the solutions are cheap or easy. For example, GM only leased its EV-1 in California and Arizona, two states where winter temperatures rarely drop below freezing.

There is no infrastructure in place to handle electric cars. Whenever electric cars rely on charging batteries, the availability of suitable charging facilities both at home and in places where electric cars may be parked is not a trivial matter. That availability may determine how effectively electric cars can be used by the public.

The charging problem is overcome if fuel cells are used as the electric vehicle power source. Then it is only necessary to store hydrogen or hydrocarbon fuel on the vehicle to feed the fuel cell and there is no requirement for external charging. Hybrid electric vehicles also bypass the charging problem by carrying their own internal charger operated from their heat engine, albeit at a significant cost penalty.

Because electric cars have not captured a large share of the market, no strong infrastructure exists to handle maintenance and repair. Currently, many problems with Toyota and Honda hybrid electric cars require the car to be taken to a company dealership for service or repair.

Some existing infrastructure, such as service stations and mechanics, will undoubtedly begin to handle electric cars just as they now handle gasoline cars. Until large numbers of electric cars are on the road, however, the owners of electric cars will be frustrated by the lack of infrastructure support compared to that for gasoline cars.

Electric cars present some safety and environmental concerns. For example, the highly toxic substances, such as lead acid, lithium and sodium-sulfur, contained in some types of batteries can cause problems. These materials require extremely careful handling, can emit dangerous vapors during recharging, and can cause harm during recycling of toxic materials or in spills from auto accidents.

One safety question concerns electrical fires in the event of an accident. These fires could become difficult to fight because of the deadly fumes coming from burning batteries. Of course, fires occur in gasoline cars as well, but early indications are that the fire safety problem may be more severe with hybrids.

The growing reliance on software raises more safety issues. And participants in fleet testing of electric and hybrid cars found an increased likelihood of vehicle failures, particularly relating to batteries and charging. While most experts believe electric cars to be safer and more reliable than gasoline cars, so far experience does not bear that out.

Some experts believe that electric cars will have higher manufacturing and maintenance costs than gasoline cars. Manufacturing costs will initially be higher because the manufacturing technology for electric cars will not be as advanced, given the novelty of the technology. But directly or indirectly, some believe that the labor to produce an electric car will generally be higher than that required for producing gasoline cars, even as experience is gained.

While some maintenance and repair costs for electric cars will be less than those for gasoline cars, the maintenance and replacement of large battery packs may skew these costs. While some solution to the battery problem may be found, until it is found battery costs will more than account for any savings due to reduced maintenance.

Regenerative braking can generate great amounts of electrical power. When a car slows from 60 mph to a stop, as much as 250 kW of electricity may be generated. A standard battery cannot handle rapid recharging at this level.

That amount of electricity cannot be stored in the battery in a short period of time.

In many cases, only about 5% of the electricity from sharp braking can be stored in the battery. The rest must be handled in some other way, requiring another system for the car and resulting in the waste of electrical energy.

In most cases, conventional mechanical braking must also be provided. That takes care of the situation where the motor/generator is running at low speed and is unable to generate sufficient energy to brake a car effectively. Or when a car needs to hold its position on a hill.

One might think that regenerative braking ability would allow lighter, lower-cost mechanical brakes to be used. Unfortunately, that may not be the case. The mechanical brakes must be able to stop the car if the electric propulsion system fails, or in the situations mentioned above.

Regenerative braking for many electrical propulsion systems can be complex and costly. The energy that can be recaptured may be small in some cases. That has led some designers to the conclusion that regenerative braking is not worth implementing.

### SUMMARY OF THE INVENTION

The invention relates to an adaptive electric car having one or more electric motors or generators. Preferably, at least one motor or generator is an adaptive electric machine made up of two or more electromagnetic circuits that are sufficiently isolated to substantially eliminate electromagnetic and electrical interference between the circuits.

Alternatively, the electric car may have an internal combustion engine connected to an electric generator and arranged in a series hybrid configuration with the one or more electric motors.

### BRIEF DESCRIPTION OF THE DRAWING FIGURES

FIG. 1 shows a block diagram of one example of an adaptive electric car.

FIG. 2 shows the basic physical structure of one example of a motor for an adaptive electric car.

FIG. 3 shows a block diagram of one example of a motor control system for an adaptive electric car.

FIG. 4 shows a block diagram of one example of power electronics that energize the stator windings in groups of three in a motor for an adaptive electric car.

FIG. 5 shows one example of the switching circuitry for each set of stator windings in a motor for an adaptive electric car.

FIG. 6 shows a block diagram of one example of a distributed, adaptive motor used in an adaptive electric car.

FIG. 7 shows a block diagram of one example of a central controller for an adaptive electric car.

FIG. 8 shows one example of a motor controller for an adaptive motor in an adaptive electric car.

### DETAILED DESCRIPTION OF THE INVENTION

This invention provides a reasonably low-priced adaptive electric car or other electric vehicle with exceptional power, efficiency and range. An adaptive electric car provides optimal performance by dynamically adapting its control system to changes in user inputs, machine operating conditions and machine operating parameters.

An adaptive electric car can take many forms. This specification uses the term “electric car” broadly to include all types of cars with an electric motor in the drive train. That includes battery electric cars, fuel cell cars, series hybrid cars, parallel hybrid cars, and possibly other types of cars

And the term “electric vehicles” is even more broadly used, since the term includes not only cars, but any vehicle that uses an electric motor to produce some or all of its propulsion. That may be a bicycle, scooter, wheelchair, car, truck, bus, train, boat, ship, airplane, even space ship.

More specifically, an electric car referred to as a “series” system generally has a generator mounted directly to a gasoline engine. All power from the engine is converted directly into electrical energy—used to drive traction motors at the axle or wheel ends. In a series system, there is no mechanical drive path between the engine and the drive wheels.

A “parallel” system maintains conventional mechanical drivetrain architecture, but adds the ability to augment engine horsepower with electrical torque. A parallel system provides operating redundancy not found in a series system. The conventional power can continue to operate in the event of an electrical power malfunction.

Isolating an adaptive electric car's motor and/or generator electromagnetic circuits allows effective control of more independent parameters. That gives great freedom to optimize and provides adaptive motors and generators for an electric car that are cheaper, smaller, lighter, more powerful, and more efficient than conventional designs. Overall, an adaptive electric car provides potentially better performance—power, efficiency, range—than a gasoline car.

An adaptive electric car with in-wheel adaptive motors delivers high power with low unsprung mass and high torque-density. The motor control system can adapt to the vehicle's operating conditions (such as starting, accelerating, turning, braking, and cruising at high speeds), thereby consistently providing higher efficiency.

Total energy management of the car's entire electrical system allows for large-scale optimization. An adaptive architecture improves performance of a wide variety of vehicles, particularly those that need optimal efficiency over a range of operating conditions.

The adaptive electric car of the present invention provides an electric car that offers exceptional power, efficiency and range at a competitive cost. An adaptive electric car has an electric motor superior to existing electric motors in torque density and efficiency.

It can adapt to a wide range of operating conditions, so that it provides optimal performance and efficiency. Perhaps most importantly, however, an adaptive electric car provides for the first time an electric car that can compete with gasoline cars on both performance and cost.

Powering vehicles with electric motors poses real problems. Operating conditions change constantly. Starting requires high torque at low speed. Cruising requires efficiency. Limits on battery power restrict range. Passing on a highway requires bursts of high torque at high speeds.

Electric motors operate most efficiently at steady speeds. In many cases, an electric motor can operate at over 90% efficiency, leaving little room for efficiency improvement. But that assumes operation within a narrow range of operating speed. Electric cars do not fit that assumption. No existing electric motor can deliver the performance demands of an electric car at reasonable efficiency and competitive cost.

Adaptive electric cars may have two characteristics that lead to high performance and efficiency over a range of operating conditions. First, adaptive motor technology permits significantly greater efficiency than existing electric motors, particularly those operating at variable speeds.

Adaptive control for individual electromagnetic circuits allows optimal performance and efficiency. In applications such as electric cars where operating conditions vary widely, an adaptive electric motor may have as much as 50% greater overall efficiency than a prior art motor.

Second, an adaptive electric car with a central controller can carry out a “total energy management” strategy that maximizes efficiency over all the motors and systems of the entire car. For example, if the state of charge of a battery becomes low, the central controller can detect that and switch into an energy conservation mode. In that mode, the controller may restrict the use of accessories and limit the power provided by the car's electric motors. That will increase efficiency.

With these characteristics, an adaptive electric car has the potential to provide exceptional efficiency over a range of operating conditions. All this provides the highest average efficiency, optimized across the torque/speed spectrum. Greater efficiency in an electric motor powering a car extends the range of the car for a given battery set and battery technology adopted—a big benefit. A goal of 90% efficiency in the power train over 90% of the typical driving cycle, both city and highway, becomes possible.

Adaptive electric motors and generators can use a distributed architecture. That allows a motor to deliver high power while operating at low voltage, 50 volts or under. In addition, the peak currents in each phase of the motor can be limited to 100 amps or less.

Even with these low voltages and low per phase currents, a set of four in-wheel adaptive motors can produce 68 kW of power and 2600 Nm peak torque, with a torque density of 21.7 Nm/kg. No existing motor technology can match that.

A distributed motor architecture, with its low voltage, improves human safety. In an electric car, these motors can deliver high power at 50 volts or less, which will not cause a fatal shock even in an accident. Existing electric car motors typically operate at much more dangerous voltages, typically from 250 volts to 500 volts.

A motor with distributed architecture also improves safety by providing extra fault tolerance. In an emergency, a motor can continue to operate even when one or more electromagnetic circuits of the motor break down.

In cases where a battery or fuel cell is used (such as in an electric car), a motor that operates at a low system voltage allows the battery or fuel cell to have fewer cells. The low voltage and distributed current make heat easier to handle, since the heat can dissipate easier when it is not so concentrated. And with lower current in each phase, less heat is generated.

The distributed architecture lowers cost by allowing cheaper power electronics to be used. It also allows smaller, lighter motors to be made with light wiring, switches and connectors. In addition, it opens the path to lower cost battery and fuel cell technologies, simplified battery and fuel cell management, and wider packaging options.

Generators with an adaptive architecture provide benefits similar to those of an adaptive electric motor. Because voltage can be kept low and current distributed across the independent phases of the generator, the same types of advantages can be gained as with motors.

Adaptive motor technology gives the highest torque density available on the market. A comparison in Table 1 of a set of four in-wheel adaptive motors to four other motors used in electric cars shows the difference in torque density.

TABLE 1
The performance of four 17 kW adaptive motors (providing a total of 68 kW)
compared with four other conventional motors.

| | Adaptive | | | | |
|---|---|---|---|---|---|
| | Motor | | | | |
| Machine Characteristics | Design | Motor 1 | Motor 2 | Motor 3 | Motor 4 |
| Peak Power (kW) | 68 (17 | 56 | 100 | 150 | 122 (30.5 |
| | kW in | | | | kW in |
| | each of 4 | | | | each of 4 |
| | motors) | | | | motors) |
| Peak Torque (Nm) | 2600 | 1069 | 550 | 2750 | 1800 |
| Peak Voltage (Volts) | 42 | 500 | 300 | 220 | 220 |
| Active Mass (kg) | 120 | 2000 | 86 | 220 | 116 |
| Torque Density (Nm/kg) | 21.7 | 0.5 | 6.4 | 12 | 15.5 |
| Notes | Brushless | Brushed | Brushless | Brushless | Brushless |
| | DC (four | DC | AC | AC | AC (four |
| | in-wheel | | | | in-wheel |
| | motors) | | | | motors) |

The adaptive motor architecture maximizes torque rating for available weight and volume. Its advanced magnetic materials and design eliminate weight while maintaining power.

High torque may be another distinguishing feature of adaptive electric motors. Conventional electric motors cannot actively manage torque well, or influence the torque at design level. That is because the choice of a specific type of conventional motor for a particular application largely determines the available torque profile.

An adaptive motor, by contrast, may typically have not only extremely high torque, but also high starting torque. It may also allow for special algorithms to increase torque if necessary, and in general actively manage torque across the range of operating conditions of the motor.

Optimal performance over a wide range of operating conditions makes adaptive electric motors and generators best suited for electric cars, perhaps the most demanding application for electric motors. In particular, adaptive motors deliver high torque at low speeds, allowing direct drive without gears or transmission. So far, almost all electric cars and parallel and serial hybrid cars have a transmission, gears, differentials or similar systems. Adaptive electric motors may make all that unnecessary.

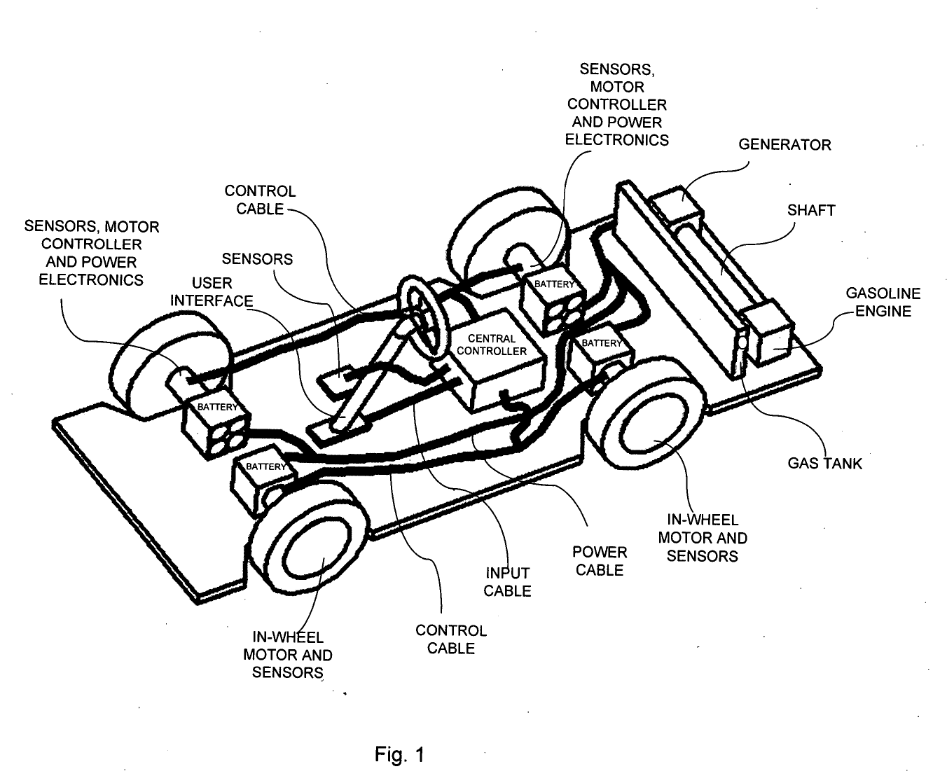

One example of an adaptive electric car has four in-wheel adaptive motors and a central controller. Each motor has its own independent controller, power electronics and battery, as shown in FIG. 1.

Including adaptive motors in each wheel of an adaptive electric car provides a vehicle architecture that allows for “true” four wheel drive. It also provides maneuvering flexibility and traction control that cannot be matched by any other electric car. And if desired, all this can be done solely in software.

With this architecture, each in-wheel motor can be controlled independently. Control is instantaneous. This independent and instantaneous traction control over each wheel provides “true” four wheel drive, since each wheel can be turned or stopped independent of any other wheel. Different wheels can even turn in different directions at the same time, something almost impossible in a gasoline car.

Instantaneous and independent control of the adaptive car's wheels enables many functions other than just propulsion. This control translates into some clear advantages over gasoline and conventional electric cars. First, an adaptive in-wheel motor can produce high torque at zero and low wheel speed.

Second, an adaptive in-wheel motor can both accelerate and decelerate the wheel. Third, torque generation of an adaptive motor is very quick and accurate, for both accelerating and decelerating. An adaptive motor provides fast frequency response and low inertia.

Fourth, generating torque in the right wheel in an opposite direction from torque generated in the left wheel permits direct yaw moment control. Movement is possible in two dimensions, right and left in addition to just backwards and forwards.

Fifth, motor torque becomes easily comprehensible. Little uncertainty exists about the driving or braking torque exerted on a wheel. With a transmission, differential and other drive line components between a gasoline engine and a car's wheels, the actual torque exerted on the wheel may be hard to determine. Brakes also make actual applied torque hard to determine.

Independent wheel control makes it possible to determine simply and in real time the driving and braking force between a wheel's tire and the road surface. This will contribute a great deal to road condition estimation and other applications.

That improves performance of several functions, some of which are listed below:
Anti-lock braking
Direct traction control
Yaw torque/stability management
Lateral stability
Brake pad life
Regeneration efficiency
Steering efficiency
Wheel speed information
Thrust performance
Stopping distance
Torque steering/split torque braking
Electrical power consumption
Road condition estimation

Electric vehicles driven by in-wheel motors have been investigated because they have advantages of compactness, high operating efficiency, and simple driveline. This requires a motor of very high power-to-weight ratio, both because of the limited space available in the wheel and the need to keep the unsprung weight as low as possible. This is not a new idea—Ferdinand Porsche designed electric cars in 1900 and 1902 using in-wheel electric motors.

A considerable amount of work has been to develop motors suitable for in-wheel use, but it is a formidable task. This is because of the cost of producing the very small, high-torque, high-power motors required. Complexity is also introduced by the desirability in some designs of using gearing between the motor and the wheel. Some, like GM with its Autonomy concept car, have given up on in-wheel motors for cars, fearing that they will always be too heavy.

Weight in the wheel of a car is very important. The handling of a vehicle is critically affected by the effect of road surface on the wheels, since they are not isolated by the suspension system. The forces generated by a bump in the road must be overcome by the springs in order to keep tires in contact with the road.

The force on the springs comes from the weight of the car. The lighter the car, the less compressive force is available from its weight. That makes it easier for the vertical motion of the wheels, caused by the bump, to overcome the inertia of the car's mass and make it move as well as the wheels. That causes a bumpy ride for passengers.

When the weight in the wheels (unsprung mass) is high relative to the weight of the rest of the car (sprung mass), the tires will not maintain a good grip on the road when cornering or passing over a bump. In addition, bumps in the road will be felt by passengers. The ideal combination occurs when the weight of the car on the springs is great, and inertia is minimized by having little unsprung mass in the wheels. That high ratio keeps the tires more firmly in contact with the road, and it also produces the best ride.

An adaptive electric motor, with its high torque density, provides more torque per kilogram of weight than existing motors. That may make it possible to use adaptive electric motors as in-wheel motors, or “hub motors,” without adding too much unsprung mass. The compactness of adaptive electric motors also make them highly suited to use in wheels.

Several other specific problems may come with in-wheel motors. Heating from braking on the motor (made worse by the difficulty of providing effective cooling) may be a problem. A motor in this exposed position may be vulnerable to damage. Cost is also a major factor in deciding if motors can be used in all four wheels.

With all these issues, an adaptive electric motor performs better than existing motors. That may allow an adaptive electric car to have in-wheel motors. Even where unsprung mass or other factors make in-wheel motors impractical even in an adaptive electric car, other motor configurations are possible to gain many of the advantages of adaptive electric cars.

Electric cars have always been criticized for their poor performance compared to gasoline cars, particularly for limited power and range. While electric cars have had better power train efficiency than gasoline cars, that has often come at an expense—the high purchase price of the electric car. An electric car is needed that matches the power, range, and pricing of the gasoline car with the efficiency of the electric car.

An adaptive electric car has the potential to outperform gasoline cars without losing the advantages of electric cars. FIG. 1 shows one example of a series hybrid adaptive electric car.

That car has the performance potential of zero to 100 mph in 10 seconds, gas mileage of 100 miles per gallon, and a range of 1,000 miles, even with the purchase price of the car being competitive with gasoline cars. This performance and pricing may be enough to overcome social inertia to make for the first time an electric car a viable, and perhaps preferred, vehicle for most consumers.

A hybrid adaptive electric car solves the long-standing problem of limited range. The efficiency and total energy management of an adaptive electric car can be gained without limiting range. In a series hybrid, a small gasoline engine, running as an alternator at a constant speed, where efficiency is highest and pollution least, can feed off the standard gas tank and produce a range of 500 miles between fill-ups.

A more elegant version might use a small turbine as the charger, or perhaps a fuel cell. The result would be the same. This serial hybrid car uses fewer driving batteries than a battery electric car, since range no longer depends on the number of batteries. A series hybrid is cheaper, lighter, and also easier to maintain than a battery electric car.

One big advantage that electric motors have over gasoline engines is controllability. No power train for a gasoline engine can practically control fine movement of a wheel, say rotating a quarter turn. Controlling the rotation of an electric motor at that level, and even much finer levels, is commonplace.

The controllability of electric motors gives electric cars an important advantage over gasoline cars. Depending on the architecture of an electric car's power train, electric motors can give advanced motion control, providing safety and improved handling. Electric motors can also be controlled to operate more efficiently.

Adaptive electric cars take that control to a higher level, providing dynamic control over a range of parameters. An adaptive electric motor or generator provides optimal performance by dynamically adapting its controls to changes in user inputs, machine operating conditions and machine operating parameters.

Isolating the adaptive motor's electromagnetic circuits allows effective control of more independent motor parameters than in existing motors. That gives greater freedom to optimize. The results are adaptive motors and generators that are cheaper, smaller, lighter, more powerful, and more efficient than conventional designs.

To improve energy efficiency, an adaptive motor control system can adapt almost instantaneously to an adaptive electric car's operating conditions, including starting, accelerating, turning, braking, and cruising at high speeds. To improve motion control, the motor controller and central controller of an adaptive electric car can directly and almost instantaneously adapt the motion of the wheels to changes in road conditions or driver inputs.

Adaptive controls can also improve operation of adaptive electric motors to reduce noise, vibration and harshness (“NVH”), eliminate or reduce audible noise, control load spikes, and provide fail-safe operation. In addition, adaptive controls can be used to compensate for changes in motor operation due to wear and tear, and to reduce torque ripple and other poor motor characteristics.

The software-based nature of adaptive controls allows car designers a great deal of freedom. Designers can fully customize a unique, “differentiating feel” for their car and develop functions based on their own intellectual property.

Software code achieves that differentiation, which used to require multiple hardware configurations. That makes development quicker than ever, with short turnaround, allowing faster response to changing market conditions without replacing hardware. This brings rapid development of real-time control programs and powerful cost efficiencies to product development and manufacture.

In fact, adaptive electric motor control technology may influence the whole design concept, general approach and technology of a car. With an adaptive control system comes total electric and electronic control of the car.

All of the motor control may be implemented in software, so that the basic control algorithms can be modified by loading new or upgraded software, without replacing any hardware. If desired, this could be done remotely, such as over the Internet. In addition, fault detection and repair may be done remotely in some cases.

With a centralized electronic control system for a car and its propulsion system, one can easily imagine endless future design opportunities. These include centralized traffic control, route programming, cruise control, auto-piloting of a car, accident prevention, recovery of lost and stolen cars, ability to deliver service, repair and upgrades to a car electronically or wireless as-you-go, future software upgrades of a car, and the like.

Adaptive electronic control of the entire car provides the chance to use control of each wheel's rotational dynamics to control the lateral dynamics of the car's chassis. “Drive-by-wire” and other electronic control schemes replace mechanical linkages. That allows adaptive control to extend throughout the adaptive electric car.

An adaptive electric car makes “plug and play” components possible. Gasoline cars have to be built around an integrated propulsion system, with the powerful gasoline engine at the center. Adaptive electric cars, like the example shown in FIG. 1, can be broken down into connected, but more independent, components.

In that sense, gasoline cars resemble mainframe computers, while an adaptive electric car resembles a distributed network. Just as with mainframe computers, all components of a gasoline car have to be proprietary components assembled by one carmaker to work together. Just as with distributed networks, an adaptive electric car brings the possibility of combining equipment from several different manufacturers, all made according to a common standard.

One can imagine, with an adaptive electric car like that shown in FIG. 1, a car dealer putting together a car with components from several manufacturers to meet a customer's order. The wheels with their motors might be made by one manufacturer, a gasoline engine/generator/gas tank module made by another manufacturer, a “user interface” combining steering, braking and accelerating controls in one joystick made by a third manufacturer, the chassis made by a fourth manufacturer, and so on.

To make this kind of “plug and play” assembly feasible, standards are necessary. Automobile consortia now promote and develop standards. Standards have always been a means of increasing reliability while decreasing cost and shortening time to market, and the auto industry is establishing new, mainly de facto ones, even though that goes against their history.

Two or three consortia now exist on interface matters alone. There is one for the controller area network (CAN), an in-car network well accepted in Europe and increasingly accepted by U.S. carmakers. But the bus is nondeterministic in that its latency is not guaranteed. So carmakers are moving to time-triggered protocol (TTP) or FlexRay. In fact, both are time-triggered architectures, in which actions are carried out on a prioritized basis at well-defined times, so actuators, motors, and all other network nodes have a common time reference based on their synchronized clocks.

Other consortia have produced such bus designs, protocols, and software environments as OSEK (a German acronym for real-time executive for engine control unit software), Media-Oriented Systems Transport (MOST), and K-Line (ISO 14230).

The specifications issued by the consortia are followed by many car companies, though some add proprietary elements. A single car may use many specifications concurrently. A BMW 745i, for example, uses the MOST bus for infotainment gear; a variety of high-speed, low-speed, and fault-tolerant CAN buses for various control applications; and BMW's own ByteFlight high-speed bus (which is evolving into FlexRay) to control airbags and other systems for ensuring the safety of a car's occupants.

Another consortium, the United States Council for Automotive Research (Southfield, Mich.), is helping manufacturers standardize such parts as connectors, control-panel light bulbs, and cigarette-lighter sockets, now mainly used as power outlets. And work is going on toward standardized implementation in electronic braking. Further, following standards reduces a manufacturer's risk of liability should problems arise.

By making it possible (and indeed preferable) to integrate all parts of an adaptive electric car under common software-based control, this architecture makes possible “plug and play” assembly for cars. That has the potential to bring great, positive changes to the auto industry.

In addition to the “plug and play” assembly possibilities, as discussed above, car owners could also upgrade their cars by simply upgrading one or a few modules at a time, without replacing the entire car. Here again, this may resemble the personal computer.

Just as the hard disk could be upgraded in a personal computer, the wheel motors might be upgraded in an adaptive electric car. Some software changes might be needed for the upgrade, but it would be much simpler and to do than with a gasoline car or an electric car without in-wheel motors.

This may also allow the body of the car to be replaced without replacing the chassis. Today in the United States there is little market, outside of collectible models, for cars ten years old or older.

While that may change if adaptive electric cars reduce the maintenance costs for cars that age, it is more likely that people will continue to want to upgrade their cars every few years. With the “plug and play” possibilities of adaptive electric cars, that upgrading can be done efficiently, replacing only part of the car and getting a “new” car at much less expense and waste.

Existing electric cars can employ a sophisticated electronic energy management system using complex software. A total energy management system can use the often limited energy available in an electric car in the most efficient way possible. Some gasoline car systems, like electronic fuel injection, operate much the same way. But electric cars can use sophisticated algorithms not possible in gasoline cars, whose gasoline engines are much harder to control than electric motors.

The typical microprocessor control system makes use of a range of inputs from sensors measuring battery, motor, vehicle and ambient conditions. It combines this information with driver-demand inputs from braking, steering, accelerator and the various switch controls available.

The control system then generates the appropriate outputs to continuously control motor torque and speed, gearing ratio (where changeable gearing between motor and drive wheels is used), regenerative braking, external lighting, heating, ventilating and air conditioning. It also controls battery recharging and other tasks, when needed.

With an adaptive electric car, the total energy management carried out by the central controller involves many more parameters, and thus provides many more opportunities for optimization, than even the best existing systems. With an adaptive electric car, each electromagnetic circuit in each motor can be effectively and independently controlled. Each energy transfer is optimized. Energy conversions are minimized.

One key objective is to increase the number of variables controlling the operation of the car, but in such a way that each variable contributes considerably to machine operation. With the motors in conventional electric cars, increasing the number of variables quickly leads to diminishing returns, since changing the variables starts to have little, if any, predictable, desired effect.

With the adaptive electric motors in an adaptive electric car, by contrast, each electromagnetic circuit may be made independent and interference between the circuits eliminated. That allows for exact control of the motor's operation on a per phase basis. It also increases the number of variables that can be meaningfully controlled. Similarly, the parameters controlling batteries and other systems can be expanded.

Reaching this key objective of a large number of variables, each with a substantial effect, may enable many of the benefits of adaptive electric cars. Standard control objectives, such as delivering required speed or torque, may be reached, and then substantially and radically expanded.

Although there are still trade-offs, now a variety of performance objectives may also be achieved. These include maximizing vehicle range, maximizing the motor's efficiency as operating speed varies, reducing acoustic and mechanical/electromechanical noise from motors, reducing battery recharging time, managing torque ripple, and optimizing the current demand off of the power source.

By tightly integrating all systems of an adaptive electric car, total energy management strategies can produce peak performance as efficiently as possible. That results in improved power, efficiency, and range without the cost of new and expensive hardware.

If an electric car can match or exceed the performance of a gasoline car, at a reasonable cost, it will probably be a commercial success. No electric car has done that. Since the invention of the electric motor in the early 1800s, no one has been able to create a motor architecture that is small enough, light enough, cheap enough, yet powerful enough to propel a car reliably and efficiently.

In the early days of the car, both gasoline cars and electric cars were rather primitive. In many respects, the electric car was superior to early gasoline cars. But by 1912, the gasoline car began to dominate the market. That dominance has never weakened, and continues unchallenged today.

But a new electric motor architecture—small, light, economical and powerful—could combine with advances in battery technology, fuel cells and/or hybrid systems to make electric propulsion a commercial reality. The technology exists today to put fuel-cell powered cars on the road powered by an electric motor, with performance that matches gasoline cars.

Unfortunately, such a car would be very expensive to buy and maintain. Without a technology breakthrough, this fuel cell/electric motor technology does not provide a practical alternative to gasoline engines.

An adaptive electric car, however, can be made at a competitive cost using technology available today. An adaptive electric car, such as the example shown in FIG. 1, takes advantage of adaptive motor and generator technology to provide power, efficiency, and range that competes with, and perhaps exceeds, the best existing gasoline cars. And at a price competitive with gasoline cars.

The propulsion system for an adaptive electric car can be assembled by plugging together components. In some respects, adaptive electric cars, like computers, can be a lot of electronics in lightweight cases. No heavy steel; no need for Rust Belt factories. Their parts can be assembled anywhere in the country.

Instead of a central production plant, there can be regional outposts, responding that much faster to local market fluctuations and putting into practice the “just in time” philosophy of manufacturing—parts arriving as needed, with no inventory pileup. Given how quickly electronics evolved, this approach could be more than convenient; it might be crucial to a producer's survival.

Not only can adaptive electric cars be easier to assemble, but adaptive electric motors can also be easier to assemble than conventional electric motors. In an adaptive electric motor, each electromagnetic circuit stands as an independent module. These modules can be made and tested before assembling. Each can be wound with its copper wire separately. By doing the manufacturing, testing, winding, and assembling on a module basis, costs can be kept low.

The motor system for the adaptive electric car derives its low cost from a variety of factors. First, the architecture's flexibility allows scalable, common components. Rather than being a single stator assembly, each electromagnetic circuit can be a separate component.

That simplifies, and thus lowers the cost, of manufacturing castings, forgings, and powdered metals. Also, the low system voltage of the motor—less than 50 volts—allows the use of cheaper components, such as MOSFETs rather than IGBTs, and easier manufacturing, since wires are of a smaller gauge.

The topology of an adaptive electric motor can be designed to minimize the iron flux path length. That results in a reduction in core losses (hystereses and eddy current losses). No eddy current losses within a permanent magnet are associated with flux generated by that permanent magnet.

Thus, the use of permanent magnets in the rotor also contributes to a reduction in flux path related losses. In addition, because permanent magnets produce magnetic flux, the torque to weight ratio of a permanent magnet rotor motor is higher than that of its iron rotor counterpart.

In an adaptive motor, flux does not flow between electromagnetic circuits of the stator, so much of the iron used in traditional stator flux paths can be eliminated altogether. The adaptive motor architecture also provides for flux path isolation of electromagnetic circuits, which significantly reduces coil-to-coil induced inductance and associated losses.

This flux path isolation structure also allows for a large degree of freedom in the choice of control strategy. Because of its lightweight and high efficiency, this type of motor makes it ideal for electric vehicles.

As gasoline cars have evolved, they have become very complex. As gasoline engines have become bigger and more powerful, engine subsystems have become increased in number, size and weight. Other vehicle systems, like transmissions, are required with gasoline engines.

With the simpler architecture of an adaptive electric car, like the example shown in FIG. 1, this process can be reversed. An adaptive pure electric or series hybrid car can eliminate the transmission, drive shaft, universal joints and transfer case. That saves a great deal of weight and cost.

Other systems will still be needed in the series hybrid adaptive electric car shown in FIG. 1. These include the battery, generator, gasoline engine, brakes, exhaust and other systems. But these systems (except for perhaps the battery) can all be simplified and “down-sized.” That reduces weight, cost and complexity.

Adaptive electric cars can perform functions without requiring the additional systems required by gasoline cars. For example, systems like antilock brakes, traction control, power steering and all-wheel drive could be consolidated or made redundant. Moving parts in the power train could potentially be reduced to a handful of bearings.

In addition to weight and cost savings, adaptive electric cars can save space by eliminating, down-sizing and “repackaging” vehicle systems. Eliminating the central drive motor and drive train (including transmission, differential, universal joints and drive shaft) gives more space to locate batteries and the gasoline engine/generator module.

Space savings and the ability to locate systems (apart from the in-wheel motors) anywhere in the vehicle gives flexibility in locating important masses to improve weight distribution. That also provides improved crash zone design possibilities, additional flexibility in locating passengers and luggage, and ability to provide a more comfortable and roomy interior, such as by lowering the floor.

In particular, with the in-wheel motors of the adaptive electric car, the space becomes empty that is otherwise occupied by the muffler, propeller shaft, and reinforcing frame in a conventional gasoline car. Using that space to house the some of the ancillary components—batteries, central controller, and other items necessary to power the car—dramatically increases the usable area inside the car.

The frame structure can often serve double duty as a storage container for batteries and other components, reducing the weight of the body. If the heaviest components and the batteries are situated below the floor, the center of gravity becomes lower and stabilizes the car. It is possible for the center of gravity to be ⅔ lower than in conventional cars.

Other systems can be down-sized. “By-wire” technology replaces the conventional mechanical linkages of accelerators, brakes and even steering with electronic controls that can be put almost anywhere in the car. This potent technology promises to open up valuable real estate in car design that was once occupied by immovable hardware.

The result? A car with less weight, more space, more power, more fuel efficiency, greater range, greater traction control, more reliability, better performance, and comparable cost. An adaptive electric car may, for the first time, provide better performance than a gasoline car, and at a competitive price.

In battery electric cars, the weight and size of the batteries or other subsystems can start a “vicious cycle” of increased weight. Stronger and therefore heavier structural components must be used to support the concentrated battery weight and provide adequate crash protection. As a rough rule of thumb, for each additional kilogram of subsystem weight at least 0.3 kg of structural weight must be added.

An adaptive electric car, like the example shown in FIG. 1, can reduce both the number of components required in a car (some systems like the transmission and differential can be eliminated completely) and the weight of those components. That starts a “virtuous cycle” of weight reduction, allowing lighter structural components to be used. The rough rule of thumb reverses, and for every removed kilogram of subsystem weight up to 0.3 kg of structural weight can also be removed.

Electric motors have proven to be reliable in many industrial applications. Most work on electric motor fault detection has generally been for large, stationary motors used in industry. Electric cars provide a much different working environment than that seen by typical industrial motors. In the coming era of hybrid electric, fuel cell electric, and pure electric vehicles, the field of motor fault detection in the context of electric vehicles will receive much greater attention.

Adaptive electric motors provide excellent fault detection and fault tolerant operation. With independent electromagnetic circuits in adaptive motors, the motor controller and central controller can detect and isolate faults down to the electromagnetic circuit level.

In most cases, the electric machine may operate on no more than 30% of its total electromagnetic circuit capacity, when necessary. So, for example, if an electromagnetic circuits in an adaptive motor stops operating, a controller can detect that.

The central controller then has several adaptive options. It can take down that electromagnetic circuit, and spread the torque load across other electromagnetic circuits. Or it may take down the entire motor, and spread the torque load across the other adaptive motors.

In either case, the car's driver can “limp home” until repairs can be made. In some cases, the effect of faults may not even be noticeable. The fault tolerance makes adaptive electric motors more reliable than conventional electric motors, and reduces the possibility that a driver may be stranded by an adaptive electric car that refuses to move.

When an adaptive electric car has independent in-wheel motors, a car or other vehicle has extra protection against failure, accidents or even (in the case of military vehicles) attack. Even if one or more motors becomes unavailable, an adaptive electric car or other vehicle can compensate for that and continue to run, even if performance suffers.

An adaptive electric car makes regenerative braking more effective. The nature of adaptive electric motors makes them very easy to control, and their architecture makes them efficient generators as well as motors.

Also, the adaptive control system for adaptive motors can handle complex control schemes. Where regenerative braking may be complex to implement for a chopper or other simple control system, the sophisticated nature of an adaptive control system makes regenerative braking much less of a challenge.

Finally, regenerative braking can generate great amounts of electrical power. When a car slows from 60 mph to a stop, as much as 20 kW of electricity may be generated. A standard battery cannot handle rapid recharging at this level.

An adaptive electric car, with the proper battery, can handle up to 70% of the energy generated by regenerative braking. That compares with many existing electric cars that can store only about 5% of the electricity from sharp braking, wasting the rest.

When an adaptive electric car has one battery pack per wheel, like the example shown in FIG. 1, the currents that have to be produced by each battery are reduced. Lower currents going in and out of the battery means longer battery life.

An adaptive electric car may improve battery performance in other ways. For example, regenerative braking is more effective when the recharging electricity flows into four separate battery packs rather than all the electricity being funneled into one battery pack.

The high power, low voltage, low current architecture of adaptive electric cars also opens the path to better battery performance. This includes lower cost battery and fuel cell technologies, simplified battery and fuel cell management and wider packaging options.

In particular, low-voltage motor systems of this invention enable a power battery to deliver higher performance. First, fewer cells in series provides better cell balance, and more robust performance. Second, simpler thermal management and voltage control reduce peripheral cost, weight and energy losses.

Third, batteries with lower-cost chemistries become possible (lead-acid or nickel metal hydride instead of lithium ion) at a higher safety factor. Fourth, low-system voltage reduces battery fade and losses in power electronics.

In one embodiment, an adaptive electric car will probably include one or more of the following: an adaptive electric motor or generator, an adaptive electric machine (motor or generator) control system, total energy management and/or adaptive battery technology.

FIG. 1 shows a block diagram of an illustrative embodiment of the present invention in which a gasoline/electric hybrid vehicle is shown with four, in-wheel adaptive electric motors. Such a configuration provides an immediate and smooth transition to an all-electric drive train that outperforms existing gasoline, hybrid or battery-only cars, and does so at a competitive cost.

Many other embodiments are also possible. Battery-only cars, fuel cell cars, cars with only one adaptive motor driving one or more wheels—all are possible embodiments of an adaptive electric car.

The adaptive electric car in this gasoline/electric series hybrid example has the following main systems: adaptive motors, battery, central controller, adaptive generator, gasoline engine, and fuel tank. An adaptive motor and adaptive generator, as these terms are used here, are adaptive electric machines with two or more electromagnetic circuits that are sufficiently isolated to substantially eliminate electromagnetic and electrical interference between the circuits.

1. Four In-Wheel Adaptive Motors

First are the four in-wheel adaptive motors. This example has four in-wheel motors, but other examples of adaptive electric cars can have two in-wheel motors, two or four near wheel motors, or one or more motors separate from the wheels. Preferably these motors will be direct drive, but gears can be used, particularly fixed ratio gears when more peak torque is desired. Planetary gears may be used even in an in-wheel motor to gain more peak torque with a smaller motor.

In this example, each motor is rated at 17 kW peak power, 2600 Nm peak torque, 42 V system voltage, and less than 30 A peak current per electromagnetic circuit. Each motor has about 30 kg active mass. Preferably each of the four in-wheel motors has the same configuration. That allows for the motors to be standardized and interchangeable.

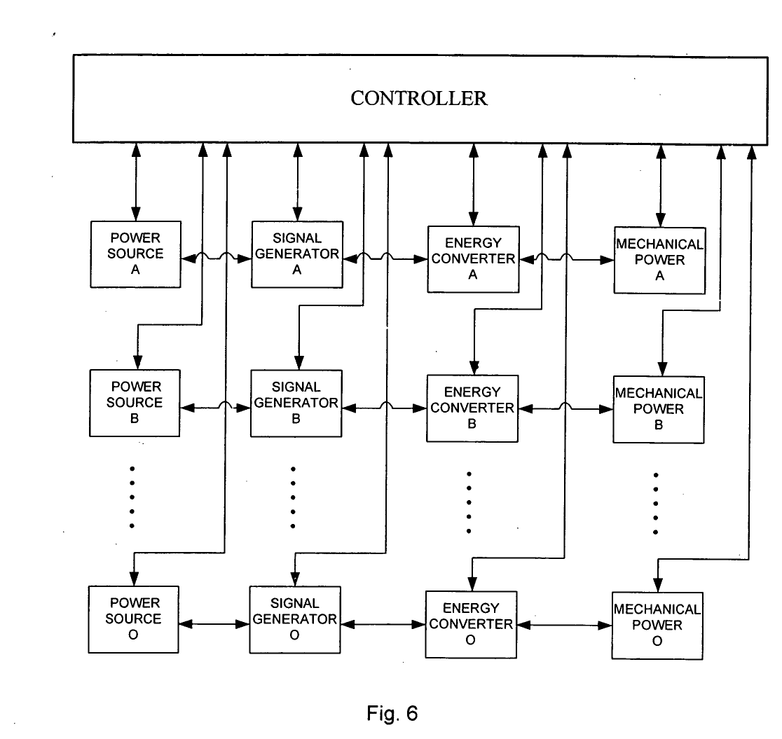

FIG. 6 shows a conceptual, block diagram of one example of a distributed, adaptive motor used in an adaptive electric car. As this figure shows, each “phase,” or electromagnetic circuit, of the motor operates independently of the other phases. All the phases are controlled by the controller.

In this FIG. 6, each phase has an independent power source, signal generator and energy converter, all combining to produce mechanical power. Isolating each phase in this way can substantially eliminate electromagnetic and electrical interference between the circuits.

The example of an adaptive electric car shown in FIG. 1 does not have a separate power source for each phase of each motor. In that figure, there is one battery per motor. And as described below, each set of power electronics (signal generator) powers three phases. So although weakened somewhat, the independence of each phase remains higher than in conventional motors.

a. Electromagnetics

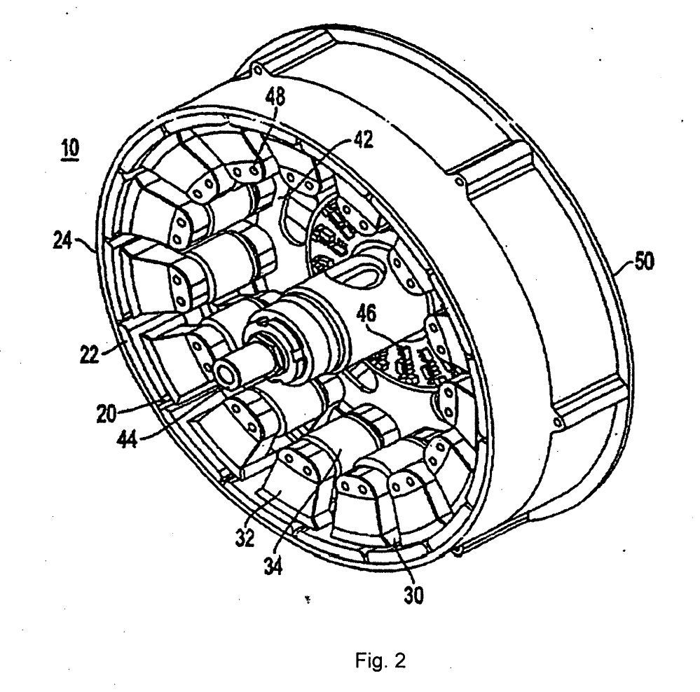

FIG. 2 shows the general configuration of the rotor around the stator in the adaptive electric motor of this example.

1. Rotor

In this example the rotor has two belts of 18 permanent magnets each, with the two belts arranged side by side along a back ring. Instead of using permanent magnets, the rotor may also have wound electromagnetic poles to increase magnetic flux and/or to help with field weakening at high speeds.

The two belts of 18 permanent magnets each have the magnets equally spaced along the air gap and affixed to a non-magnetic circular back plate. The magnetic polarity of the magnets in each belt alternates from north to south going around the belt. The belts lie side by side along the back plate. The magnetic polarity of each belt's magnets is offset so that a north pole in one belt lies alongside a south pole in the other belt, and vice versa.

The magnets of each ring successively alternate in magnetic polarity. The magnetic flux produced by the rotor's permanent magnets may be enhanced by adding a magnetically permeable element (not shown) mounted to the back of the rotor permanent magnets.

The number of rotor magnets is just for this example. That number may be changed. For example, fewer magnets spaced at greater distances may produce different torque and/or speed characteristics.

The choice of which permanent magnets to use usually means trading better performance for lower cost. In this example the permanent magnets are NdFeB (neodymium iron boron) permanent magnets of a nominal BHmax or energy product ranging between 238 to 398 kJ/m 3 (30 to 50 MGOe).

Shaping the magnets in rounded sectors with square cross sections and tapered edges may help minimize cross interference of unwanted magnetic flux. The magnets may be radially magnetized to provide strong magnetic dipoles perpendicular to the plane of the back plate for each partitioned section of the rotor.

The back plate may be formed of aluminum or other non-magnetically permeable material. The back plate may form part of the electric machine housing, which has side walls attached to it.

2. Stator

In this example, the stator has 15 electromagnet pairs, with each pair arranged lengthwise around a circular central circular ring. Each electromagnetic pair is a U-shaped electromagnetic core, with the two upright legs of the “U” being wound with copper wire to function as electromagnetic poles. These stator windings are switched by power electronics to form the alternating electromagnet field that forces the rotor to rotate.

Complex three-dimensional shapes of the electromagnetic cores can be used in this motor to improve performance. To make those shapes more easily, the electromagnetic cores may be manufactured from Soft Magnetic Composite (“SMC”) powder alloys or alloyed sintered powder materials (“SPM”), as opposed to laminated electrical steel.

These SMC and SPM alloys come in innovative isotropic powder matrices. Each grain in the powder matrix is insulated from the other grains, using a resin bonding agent or oxide layer. That results in extremely high electrical resistivity compared to the best high-silicon steels (1000 vs. 40 to 50 μohm cm). They also have very low eddy current loss at the relevant frequencies and magnetic flux densities.

These SMC and SPM alloys allow stringent geometrical constraints and the required electromagnetic characteristics to be specified for each particular motor design. Using these complex three-dimensional shapes may significantly reduce the weight of the stator, and make them easier to manufacture.

In this example, each electromagnetic circuit, or “phase,” of the adaptive motor has been sufficiently isolated from each of the other electromagnetic circuits to substantially eliminate electrical and electromagnetic interference between the circuits. This may increase the number of independent machine parameters that may be varied and controlled. As a result, this may increase the effective response of the electric machine to control and optimization.

In addition, each electromagnetic circuit, structurally and/or electromagnetically separated from each of the others, may receive a separate control signal from the motor controller. That controls the electrical flow in each group of electromagnetic circuits independently of electrical flow in each other group. That may allow each electromagnetic circuit, or phase, to be controlled independently of each other phase.

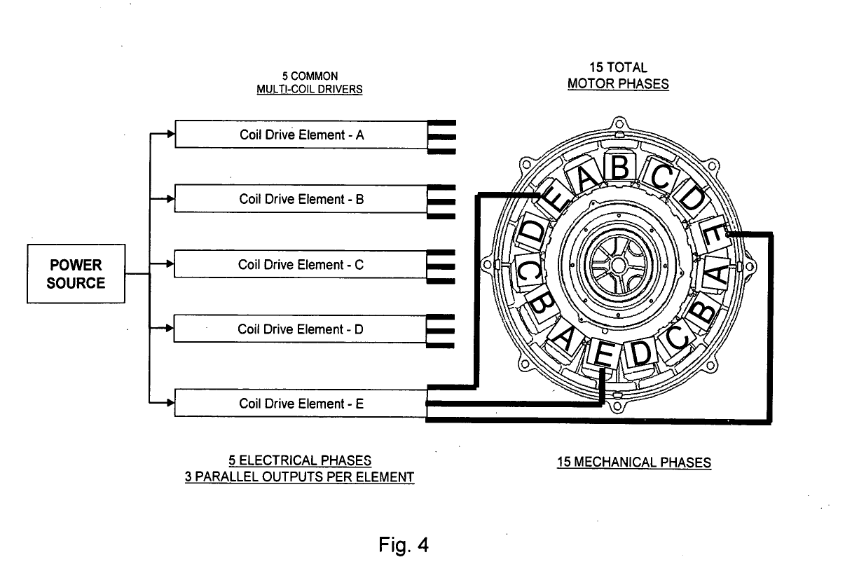

As an independent electromagnetic circuit, each “phase” of the motor can be driven independently. But to minimize the complexity of the system, and to reduce the number of power electronics required, the 15 phases of the motor of this example are divided into five groups of three “phases” each. FIG. 4 shows this.

b. Power Electronics

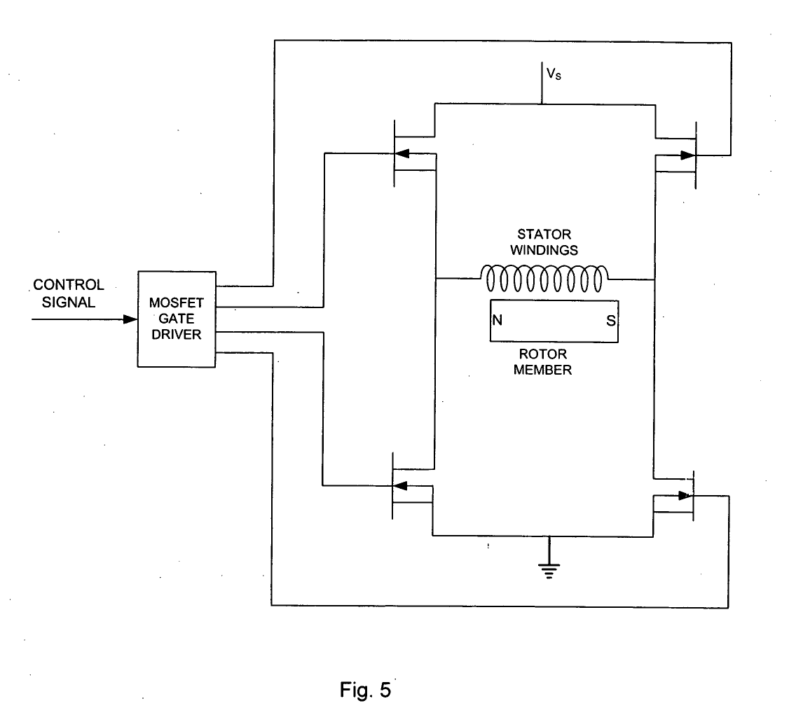

Electronic switches energize the motor windings in this example, as is well known in the art. FIG. 5 shows a partial circuit diagram of the switch set and driver for an individual stator winding. Four MOSFETs acting as a switch set connect each stator winding in a bridge circuit. A MOSFET H-bridge, such as International Rectifier IRFIZ48N-ND, may be used as an electronic switch set.

A MOSFET bridge circuit can shape the voltage and current used to energize the stator windings. This can be done by pulse width modulation, a technique well known in the art. A digital signal processor (DSP) or other microprocessor generates the control signal to drive the MOSFETs.

The bridge circuit for pulse width modulation may be a full or a half bridge circuit. While a four-MOSFET switch set is shown here, any of various known electronic switching elements may be used to provide driving current in the appropriate direction to the stator windings.

One example (shown in FIG. 4) has five sets of power electronics, with each set driving three separate stator windings. The number of sets of power electronics for this 15-stator pole motor can also be 15 sets, or any number that is a factor of 15. Fifteen sets give the most independent parameters to optimize, but may also be the most costly.

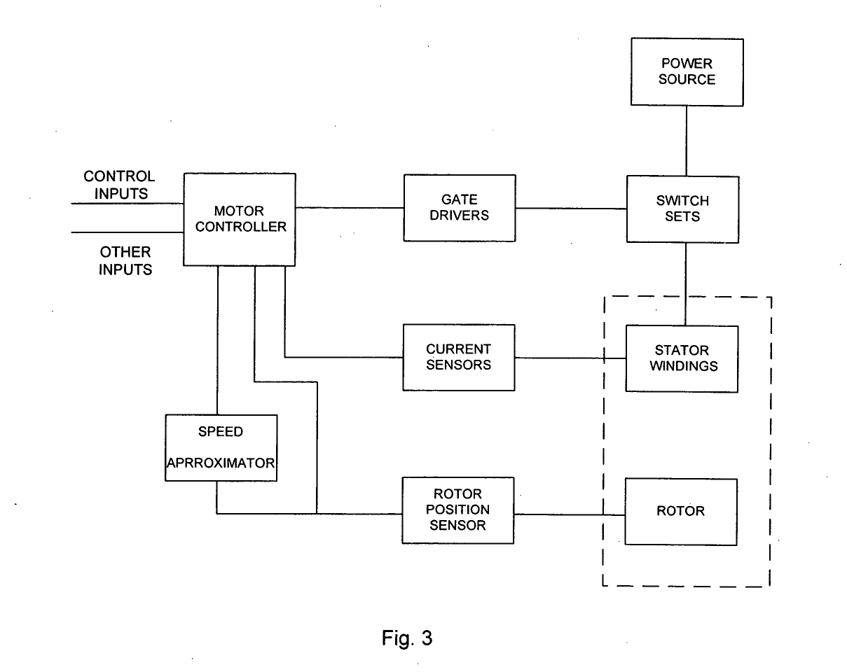

Five sets of power electronics (as shown in FIG. 4) may be a good compromise between cost and complexity on the one hand and ability to optimize on the other. As is shown in FIG. 3, a control signal from the controller controls the MOSFET gate driver, which in turn drives the MOSFET switch set. The MOSFET switch set sends the driving current from the power source through the stator winding in the appropriate direction.

FIG. 5 shows the switching circuitry for each set of stator windings. The motor controller varies the amount of voltage and current being sent through each stator winding using pulse width modulation. Thus, the motor is driven by varying both the amount of voltage and current being sent through the stator winding and the direction of the current.

The number of sets of power electronics can also be increased to reduce the amount of current that needs to handled by each switch set. For example, if 15 sets of power electronics are used instead of five, the amount of current that needs to be handled by each set drops by two-thirds.

c. Motor Controller

The motor controller controls the amount and direction of the current sent from the power source to the stator windings. It does this by controlling the gate drivers, based on inputs from current sensors, a rotor position sensor, and a speed approximator.

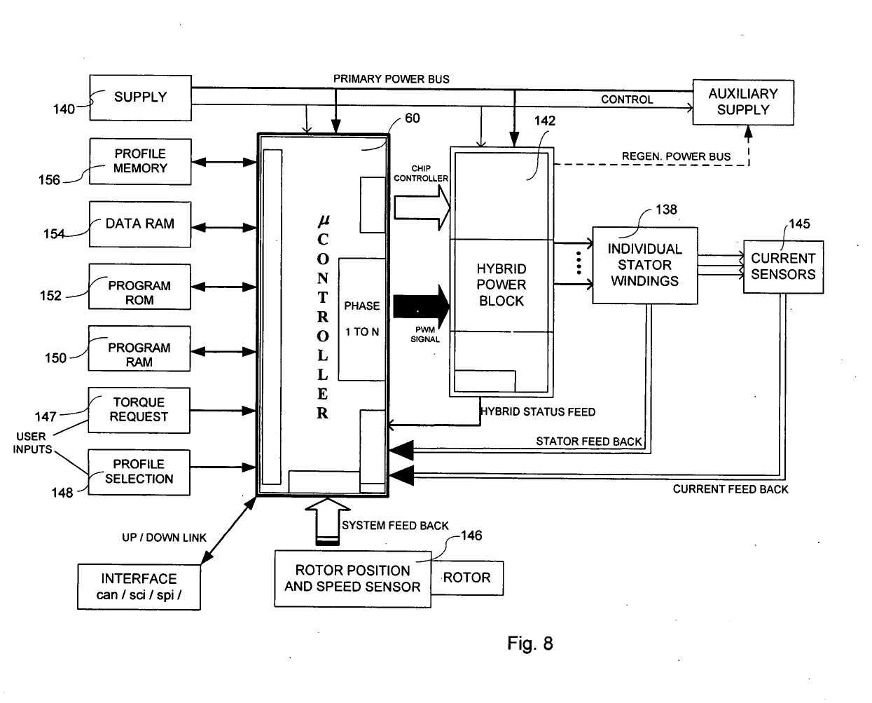

FIG. 8 shows one example of a motor controller. In this example, the controller is a Texas Instrument digital signal processor TMS320LF2407APG. The controller also needs memory to store current driving profiles, other data, and programs. In this example, the controller has four memories.

To improve performance, the motor controller may dynamically adapt the torque/speed/efficiency characteristics of the motor. As parameters—driver inputs, sensor inputs for each motor system, and sensor inputs for the vehicle—vary, the operation of the motor may be changed to adapt to those variations.

Most adaptive control systems will be optimized to balance:
functional requirements
performance quality
system efficiency
system safety
fault tolerance

The distributive architecture of an adaptive electric motor allows circuit independence, while balancing configuration, circuitry, power requirements, component complexity, and software complexity. Based on the user inputs and environmental, motor or system conditions, the control priorities may be adapted to optimize performance.

For example, if a car requires high torque to climb a hill at low speed, from a standing start, the motor controller may adapt to provide that. If the car needs high torque to pass on a freeway at 70 miles per hour, the motor controller may provide that.

As another example, a sine waveform profile may be used by the motor controller to extend battery life through its more efficient operation. However, in most cases, a power supply is rated for a maximum current discharge rate. If the motor controller receives a control input that requires the maximum current draw, the motor output may be limited to relatively low torque if the sine waveform profile.

If the motor controller determines that the motor needs to generate more torque than the sine waveform profile can provide, the controller may switch to a square wave profile. The square wave profile will produce more torque than the sine waveform profile without exceeding the maximum rating of the power supply. However, the power loss will increase by about 40%, greatly reducing efficiency.

A variety of different algorithms may be implemented in the motor controller to achieve optimal results. For example, a motor controller for an adaptive electric motor may use a phase advance scheme to counter the problems caused by back EMF building up at high speeds.

In general, the motor controller optimizes the performance of the adaptive electric motor by dynamically selecting a control scheme in response to user inputs, machine operating conditions and machine operating parameters. To do this, a motor controller may use a variety of control algorithms, including the torque/efficiency optimizing and phase advance algorithms described above. At least three types of algorithms come to mind.

First are performance-oriented algorithms. Here, the controllable parameters are calculated to optimize performance at given speeds and torque. The torque/efficiency optimizing and phase advance algorithms discussed above fall within this category.

Other algorithms can include measures designed to damp the vibrations or other handling problems that may be caused by bumps or other irregularities in the road surface. In fact, these algorithms can be used to counteract, at least to some degree, the effects of the unsprung mass in the wheels of the car.

This software-based, dynamic damping of the in-wheel motor drive system may result in better road-holding performance and a more comfortable ride than are possible with conventional in-wheel systems. It may offer advantages over conventional, single-motor electric cars, or even over gasoline cars, in safety and comfort.

Second are algorithms oriented toward working around faults. Here, the controllable parameters are re-calculated based on specific fault information so a given speed-torque profile may be maintained. Other desired performance characteristics can also be optimized to the extent possible.

For example, the central controller can work around faults. Each “phase,” or electromagnetic circuit, of an adaptive motor may be independent. In that case, the central controller or motor controller can compensate for one phase becoming inoperable. The motor will operate, but with increased torque ripple, increased cogging and decreased torque.

That fault tolerance alone may be a big advantage over other motor designs. But with appropriate algorithms, the controllers may compensate even for these faults, reducing torque ripple and cogging, and increasing torque contribution from other phases to keep torque up.

Third are algorithms geared toward dealing with manufacturing tolerances and wear. These algorithms are based on the premise that each part of a motor, although manufactured to specification, may have some deviation from that specification. These algorithms may correct for such deviations, as well as deviations caused by wear.

Because these algorithms have to do with specific motor performance, they are probably best implemented in the motor controller rather than the central controller. But they may do implemented in either place.

The motor controller must also be able to control the motor as a generator, when it performs regenerative braking. The adaptive architecture of the in-wheel motors in this example facilitate regenerative braking.

d. Control and Sensor Inputs

The control inputs to the motor controller comes, in this example, from a central controller. In other examples, the control input can come from user input or other source. Based on the control and sensor inputs, the motor controller creates a current profile to drive the stator windings.

Each motor in this example may need to have its independent absolute angular position sensor. This could be based on any of several technologies, such as optical, inductive, capacitive or magnetic.

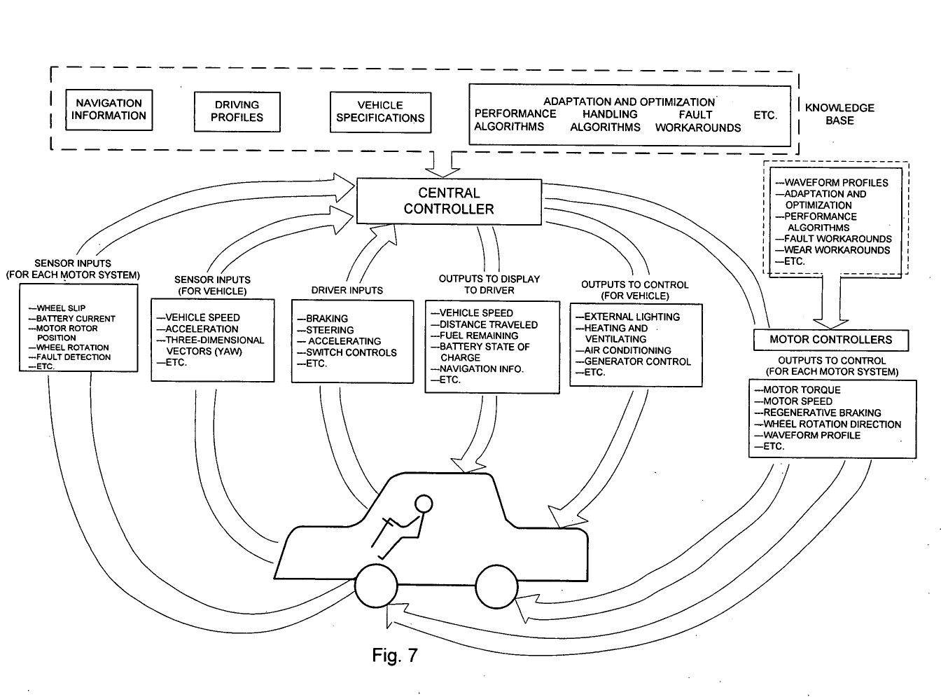

Other sensing for each motor system can also be done. As shown in FIG. 7, parameters such as wheel slip, battery current, battery temperature, power electronics temperature, motor temperature, wheel rotation, and faults can be sensed. Information from the sensors may go to the motor controller or the central controller.

Sensing for the vehicle can also be done. These parameters may include vehicle speed, acceleration, inside air temperature, outside air temperature, and three-dimensional positioning (such as yaw detection).

Driver inputs may include braking, steering, accelerating, and switch controls. With the adaptive electric car in this example, the “user interface” to get driver inputs can be electronically linked, rather than mechanically linked. That makes a variety of user interface devices possible—mice, joysticks, or even voice commands—instead of the traditional steering wheel, brake and accelerator.

e. Cooling

If maximum power is to be drawn from an electric motor it is necessary to provide cooling of windings on the stator and rotor and also of other vulnerable parts such as permanent magnets which may be incorporated into the motor design. Depending on the motor type, size and duty cycle, this cooling may be provided by air or a liquid coolant system.

For an electric car motor, cooling may be by air, oil or water. Forced air cooling is the method used in most lower-rated motors. If air cooling is to be effective, ducting must be provided to get the cooling air to those components which dissipate the most heat, such as stator windings.

However, ducting means that the motor is larger than would otherwise be the case. Thus, there is some compromise required between improved cooling, motor size and weight. This has led to the replacement of air with water and oil. These liquids allow more effective cooling with smaller ducting and result in a motor of reduced weight and size and higher specific output.

With water, electrically live parts of the motor must not contact the water unless deionized water is used. Oil and splash cooling do not have this problem. There, ducting adjacent to the electrical windings can be safely used to cool both rotor and stator. However, oil cooling may cause some viscous drag if oil enters the air gap between rotor and stator.

Oil also has the advantage that the cooling function can be combined with the lubrication function, particularly in a propulsion system with integral motor and gearbox. In the case of both oil and water a radiator is sometimes required to remove the heat from the cooling fluid. This heat may be used by the vehicle heating system.

2. Four Batteries

In this example, each of the four in-wheel motors has its own battery next to it. A battery is used as the electrical power source in this example. More generally, this power source can be a battery, fuel cell, generator, or any other source of electricity.

Ideally, even each “phase” or electromagnetic circuit of each motor would have its own separate power source. When the power sources have no electrical connection to each other, the line current between the power source and the electromagnetic circuit can be kept low. In addition, electrical interference between the circuits can be essentially eliminated. That improves motor controllability.

For optimum battery performance, the batteries should be designed as described in ●U.S. Pat. Nos. 5,370,711 (“Multi-Roller Winder Method”), U.S. Pat. No. 5,439,488 (“Method for Making Large Cells”), U.S. Pat. No. 5,667,907 (“Electric Vehicle Designs”), and U.S. Pat. No. 6,265,098 (“Cell Designs, Single Pressure Vessel, and Current Collector”).

These batteries make moving electrical power in and out of batteries much quicker and more efficient, regardless of the battery chemistry. These batteries may be ideal for hybrid cars due to their ability to deliver high power during hard accelerations and efficiently recapture significantly more energy during regenerative braking.

This battery technology delivers both high power and high energy in a single design by manufacturing the battery cells in a spiral-wound stack rather than a cylindrical structure. Its current collector technology enables power to pass through the body of the wound cell, directly from one cell to the next. Conventional batteries use small current collectors to pass the power between cells.

3. Central Controller

In this example, the central controller performs total energy management of all the adaptive electric car's systems. This permits the available electrical power to be used in the most efficient way possible. Through the central controller and the motor controllers, the electric car can be dynamically adapted, during operation, to a variety of conditions.

The central controller makes use of a range of inputs from sensors, as shown in FIG. 7. These include separate sensors from each of the four in-wheel motors, and sensor inputs for the entire vehicle. The central controller combines this information with driver inputs received through the “user interface.” Typically, these driver inputs include braking, steering, accelerator and the various switch controls.

The central controller can then combine these inputs with stored information from a knowledge base. The knowledge base may contain adaptation and optimization algorithms, stored driving profiles, vehicle specifications, and navigation information. Based on all this information, the central controller optimizes for best performance. This requires sending control signals to each of the in-wheel motors to continuously control motor torque and speed.

As interfaces between the central controller, the motor controllers, and other components, either existing or proprietary interfaces can be used to enable communications control, input/output functions, feedback loops, and other necessary functions. These interfaces enable a great deal of customization by car designers.

Existing interfaces include the controller area network (CAN), an in-car network well accepted in Europe and increasingly accepted by U.S. carmakers. But the bus is nondeterministic in that its latency is not guaranteed. So carmakers are moving to time-triggered protocol (TTP) or FlexRay. In fact, both are time-triggered architectures, in which actions are carried out on a prioritized basis at well-defined times, so actuators, motors, and all other network nodes have a common time reference based on their synchronized clocks.

Other bus designs, protocols, and software environments are available. These include OSEK (a German acronym for real-time executive for engine control unit software), Media-Oriented Systems Transport (MOST), and K-Line (ISO 14230). A single car may use many specifications concurrently.

The central controller can perform electronically the “differential function” that in gasoline cars typically requires a mechanical differential. The differential function means dividing the power over the driving wheels. As the driving conditions change, for example as a car rounds a curve, each in-wheel motor will be fed with the necessary current to propel the wheel with the correct speed and torque.

Having four in-wheel motors, each capable of zero speed torque, allows many functions not possible in a gasoline car or conventional electric car. The motor systems can perform car functions not possible with other propulsion systems. That allows for some vehicle systems to be eliminated or downsized.

For example, the central controller may be used to provide improved anti-lock braking systems, traction control, and yaw stability control. Control can be carefully exerted on a wheel with a low coefficient of friction. Each wheel motor can contribute to braking, absorbing brake energy to extend brake pad life and reduce brake dust on the wheels.

Other system functions can be done. A “hill hold” function can be implemented. Off-road control can be made more precise. A mechanical wheel lock feature (like transmission park lock) can be implemented solely with electronic brakes.

Low speed torque steering can be created by a differential in wheel torque. That allows power steering assist, and performs a yaw torque function at low vehicle velocities and low coefficients of friction.

As noted, the central controller can control the torque and speed of each individual motor to provide improved traction control. With each motor having its own motor controller as well, the distributed control system and direct-drive features provide independent wheel control both in acceleration and braking. That allows software algorithms to easily integrate a four-wheel anti-lock braking system and direct traction and/or stability control functions.

An electric motor in each wheel allows instantaneous torque distribution to each wheel across the zero to maximum torque range. Wheels can also turn in different directions, and reverse direction instantaneously. That allows for many sophisticated algorithms to improve vehicle performance.

For example, the central controller could have an algorithm for a rocking motion to get the tires out of trenches in snow. The central controller could move the car backward until it senses the wheels slipping, then switch the motors forward until it senses slipping, when it again reverses, and so on until the car can move forward without slipping.

The central controller also controls and optimizes the electrical power generated by the gasoline engine/generator module and by regenerative braking. Algorithms operating in the central controller can provide maximum regenerative service braking for optimal energy recovery in urban use, extending range and improving overall system efficiency. It controls all power flowing in and out of the batteries, and monitors the battery current and temperature.

The central controller can also be used to implement a “drive by wire” steering system. That takes away the need for a mechanical linkage between a steering wheel and the wheels being steered. So designers can use a joystick, mouse or other device to replace the steering wheel of a car.

In this example, navigational information is also available to the central controller to be processed by it to provide navigation instructions to the driver. The central controller also provides information for the driver instruments showing speed, distance traveled, fuel remaining, battery states of charge, and similar information.

The central controller will control external lighting, heating, ventilating and air conditioning, de-misting, de-icing and seat heating. Currently these systems require 12 V, but increasingly designers are suggesting a move to a 42 V power supply for these systems even in gasoline cars.

4. Control and Sensor Inputs

FIG. 7 shows how the central controller receives various inputs, draws on necessary information (driving profiles, vehicle specifications and navigation information), and produces the appropriate outputs.

The central controller makes use of a range of inputs from sensors, as shown in FIG. 7. These include separate sensors from each of the four in-wheel motors, and sensor inputs for the entire vehicle. The central controller combines this information with driver inputs received through the “user interface.” Typically, these driver inputs include braking, steering, accelerator and the various switch controls.

The central controller can then combine these inputs with stored driving profiles, vehicle specifications, and navigation information. Based on all this information, the central controller optimizes for best performance. This requires sending control signals to each of the in-wheel motors to continuously control motor torque and speed.

For example, in wheel skidding the velocity of the rotating wheel changes rapidly. When a wheel skids while accelerating, the wheel rapidly spins out of control. When a wheel skids while braking, the wheel suddenly stops, in a wheel lock. An adaptive electric car can easily sense these rapid changes in wheel velocity.

Sensing those changes in wheel velocity allows the motor and/or central controller to dynamically, and almost instantaneously, adapt to them. Not allowing the wheel to spin out of control while accelerating helps move the car. Similarly, not allowing the wheel to lock while braking helps stop the car.

5. Adaptive Generator

In this example, the electrical power to move the car comes from a gasoline engine/generator module. The generator preferably has an adaptive architecture. That allows it to operate more efficiently. The basic structure of an adaptive electric generator resembles the adaptive electric motor structure outlined above.

In particular, the adaptive generator in this example has “phases,” or electromagnetic circuits, that are sufficiently isolated to substantially eliminate electromagnetic and electrical interference between the circuits. Also, the generator will have a generator control very similar to a motor controller.

6. Gasoline Engine

In this example, the gasoline engine does not provide power to move the vehicle. It only rotates the adaptive generator to produce electrical power. Preferably, a lightweight gasoline engine of between 10 to 15 horsepower that operates efficiently at a constant speed should be used. The gasoline engine is turned on and off by the central controller so that it only operates when the batteries need to be charged.

7. Fuel Tank

In this example, a standard fuel tank holding ten gallons of gasoline is used.

This detailed description of an adaptive electric car provides one example. There are many others. This invention should not be considered limited to this or any other example.

1. An electric vehicle, comprising:
one or more electric motors and/or generators,
wherein at least one motor and/or generator is an adaptive electric machine comprising two or more electromagnetic circuits that are sufficiently isolated to substantially eliminate electromagnetic and electrical interference between the circuits.

2. The electric car or other electric vehicle of claim 1 which has an internal combustion engine, steam engine, or turbine engine connected to an electric generator and arranged in a series hybrid configuration with the one or more electric motors.

3. The electric car or other electric vehicle of claim 1 which has a fuel cell arranged in a series hybrid configuration with the one or more electric motors.

4. The electric car or other electric vehicle of claim 1 which has an internal combustion engine, steam engine, or turbine engine arranged in a parallel series hybrid configuration with the one or more electric motors.

5. An electric car or other electric vehicle with one or more electric motors to move the vehicle,
where the torque/speed/efficiency characteristics of at least one electric motor can be dynamically adapted to varying torque, speed, acceleration, braking and other operating conditions of the vehicle to optimize vehicle performance.

6. The electric car or other electric vehicle of claim 5 which has an internal combustion engine, steam engine, or turbine engine arranged in a series or parallel hybrid configuration with the one or more electric motors.

7. The electric car or other electric vehicle of claim 5 which has an internal combustion engine, steam engine, or turbine engine connected to an electric generator arranged in a series hybrid configuration with the one or more electric motors.

8. An electric car or other electric vehicle with an in-wheel electric motor in at least one wheel of the vehicle including vehicles with a motor at each wheel of the vehicle, each motor with its own motor controller and power electronics.

9. The electric car or other electric vehicle of claim 8 with a separate battery for each electric motor.

10. The electric car or other electric vehicle of claim 8 with:
a separate battery for each electric motor,
a gasoline engine, steam engine, or turbine engine/generator module to produce electrical power to charge the batteries,
a user interface to get input from the driver of the vehicle, and
a central controller that controls operation of the motors, batteries, and gasoline engine, steam engine, or turbine engine/generator module.

11. A method of propelling a car or other vehicle with one or more electric motors, the steps including:
periodically sensing one or more driver inputs, sensor inputs (for each motor system) and/or sensor inputs (for vehicle), and
allowing the torque/speed/efficiency characteristics of at least one motor to be dynamically adapted to changes in the one or more inputs and/or sensor inputs.
